(19) United States
(12) Patent Application Publication
(10) Pub. No.: US 2025/0102435 A1
(43) Pub. Date: Mar. 27, 2025

(54) SYSTEM FOR DETECTING BIOLOGICAL REACTIONS ON A SUBSTRATE USING WAVEGUIDES AND NANOPORES

(71) Applicant: GENOPORE LTD, Ramat Gan (IL)

(72) Inventors: Yigal LEIBA, Kiryat Ono (IL); David BAUM, Ramat Gan (IL); Oren MANSOUR, Ramat Gan (IL)

(21) Appl. No.: 18/730,918

(22) PCT Filed: Jan. 23, 2023
(86) PCT No.: PCT/IL2023/050071

§ 371 Date: Jul. 22, 2024

Related U.S. Application Data
(60) Provisional application No. 63/267,058, filed on Jan. 24, 2022.
(60) Provisional application No. 63/439,938, filed on Jan. 19, 2023.

(51) Int. Cl. G01N 21/64

(52) U.S. Cl. CPC G01N 21/6428; G01N 21/6452; G01N 2021/6463

(57) ABSTRACT

A device for fluorescence-based detection of at least one polymer, the device including at least one container, at least one light source, at least one detector and at least one optical element, the container including a nanopore membrane and a waveguide layer, the nanopore membrane including at least one nanopore and the waveguide layer including at least one opening, the light source optically coupled with the waveguide layer and for generating at least one light beam for illuminating the polymer, the detector for detecting at least one emission emitted from the illuminated polymer and the optical element for entering the light beam into the waveguide layer, the opening being positioned substantially in line with the nanopore, the polymer being illuminated by the light beam propagating through the waveguide layer through the opening and the illuminated polymer emitting the emission as it passes through the nanopore and the opening.

### FIELD OF THE DISCLOSED TECHNIQUE

The disclosed technique relates to biological as well as biochemical reactions, in general, and to methods and systems for fluorescence-based detection and analysis as well as the identification of biological and biochemical reactions and polymers, in particular.

### BACKGROUND OF THE DISCLOSED TECHNIQUE

Fluorescence is a well-known physical phenomenon characterized by an emission of light in reaction to either absorbed light or other electromagnetic radiation when impinging upon certain substances. Fluorescence usually involves a light source that is external to the substance, and thus fluorescence may be considered as re-emission of light originating from the environment outside the substance. As is known in the art, emitted fluorescent light usually has a longer wavelength than that of the absorbed light, and therefore lower energy than the absorbed radiation.

Some materials are considered as fluorescent substances, whereas other materials are considered phosphorus substances. Both fluorescence and phosphorescence are characterized by an emission of light from a substance in response to an excitation. The excitation is caused by absorption of energy from incident radiation or particles. Fluorescence and phosphorescence differ in the “delay” between the time of initial excitation and the time of initial emission. Fluorescence and phosphorescence also differ in the length of time the emission lasts after the excitation stops. In particular, a common distinction is made between fluorescent materials, which cease to glow nearly immediately when the radiation source stops, and phosphorescent materials, which continue to emit light afterwards.

In fluorescence, an electron in the substance is excited (e.g., by a light photon) from a certain energy level (considered as a baseline or a ground level) to a higher level (considered an excited state). Transition of the electron back to the ground level can occur spontaneously with radiation of the energy it absorbed. Such a return is almost immediate, occurring within 10⁻⁸ seconds or so. The case for phosphorescence is different. In phosphorescence, there is an intermediate energy level (interposed between the ground level and the excited state) called a metastable level, or electron trap. The metastable level is created because a transition between the metastable level and other levels is “forbidden” (or highly improbable). Once an electron has fallen from the excited state to the metastable level, it remains there until it makes a “forbidden” transition or until it is further excited again. The time spent in the metastable level determines the length of time that phosphorescence persists.

Fluorescence is found in many fields and has numerous industrial applications. Fluorescence can be used for detection purposes, such as the detection of a physical phenomenon, the detection of chemical reactions as well as the detection of biological reactions. Examples in the field of detecting biological reactions include protein quantification at low concentration, water quality analysis, time-resolved fluorescence for monitoring food composition, studying heart disease and the like. Fluorescence can also be used to analyze and determine at least a portion of the constituents of a polymer as different fluorescent monomers within the polymer may emit fluorescent radiation at different wavelengths.

Fluorescence based detection of biological and biochemical reactions and markers are known in the art. Reference is now made to FIG. 1A, which is a schematic illustration of a setup, generally referenced 20, of a prior art setup for detecting biological reactions. Setup 20 shows an apparatus for detecting the presence of a fluorescent marker in a biomaterial 26. The apparatus (not labeled) includes a container 22, a light source 28 and a detector 30. In setup 20, container 22 includes a solution 24 in which biomaterial 26 is positioned. Light source 28 radiates or transmits light beams 32 and 36 (brought as examples) towards container 22 in which biomaterial 26 is either submerged (as shown) or floating in solution 24. As shown, light beam 32 hits the surface of solution 24 and reflects as a reflected light beam 34 towards detector 30, without excitation of biomaterial 26. On the other hand, light beam 36 (which arrives at a different angle) enters solution 24 as a light beam 38 and impinges on biomaterial 26. As a result, biomaterial 26 emits a light beam 40, which exits solution 24 and is received by detector 30 as an emitted light beam 42. Light beam 38 which originated from light source 28 has a different wavelength than light beam 40 which originates from biomaterial 26 as biomaterial 26 absorbs light beam 38 and emits light beam 40. Thus as shown, light beams 38 and 40 have different arrow types to emphasize the difference in wavelength. For purposes of clarity, to emphasize the different origins of the light beams as drawn, a different type of line is used for light beams 40 and 42 (both drawn as dashed lines) as compared to light beams 32, 34, 36 and 38 (all drawn as solid lines). As shown, in accordance with Snell's law, light beam 36 and light beam 38 have slightly different angles due to the difference in index of refraction between the environment outside container 22 and solution 24. The same is noted with respect to light beams 40 and 42 at the boundary between solution 24 and the air above the solution.

Detector 30 receives emitted light beam 42, which originated from biomaterial 26, and can be coupled with a processor (not shown) for detecting a biological reaction (i.e., the presence of a fluorescent marker in biomaterial 26) based on the characteristics of emitted light beam 42. As shown, although detector 30 is built and positioned to detect emissions originating from biomaterial 26, detector 30 also receives light beams not originating from biomaterial 26, such as reflected light beam 34. Reflected light beams not originating from biomaterial 26, such as reflected light beam 34, can become a source of noise for detector 30. Light beams (not shown) arriving at detector 30 directly (i.e., without any reflection) from light source 28 are also considered as noise and may cause saturation in detector 30.

Reference is now made to FIG. 1B, which is a schematic illustration of another setup, generally referenced 50, of the prior art for detecting biological reactions. Setup 50 represents an improvement of the prior art over the setup shown in FIG. 1A, especially for overcoming noise which may originate from an external light source. Setup 50 includes a container 52, a light source 28, a light source filter 62, a microscope 58, a microscope filter 64 and a dichroic mirror (herein abbreviated DM) 60. In setup 50, container 52 includes a solution 54 in which a biomaterial 56 is positioned. It is noted that the surface of solution 54 presents capillarity at the edges near container 52 however such capillarity is not necessary for the purposes of detection. Light source filter 62 is placed adjacent to light source 28 and microscope filter 64 is placed adjacent to microscope 58. DM 60 is placed in such a way that light originating from light source 28 will reach biomaterial 56. In the example presented in FIG. 1B, DM 60 is placed at an angle of 45 degrees with respect to a light beam 66 originating from light source 28.

As can be noticed by comparing FIG. 1B to FIG. 1A, there is a slight difference in position between biomaterial 56 and biomaterial 26 (FIG. 1A). Biomaterial 56 is drawn adjacent to the bottom of container 52, as if sunk in solution 54, whereas biomaterial 26 is drawn as floating in solution 24 (FIG. 1A). This difference is made for illustrative purposes only. In real world applications, different solution and biomaterial combinations will yield different results as to what degree the biomaterial will be submerged in the solution.

As shown in FIG. 1B, microscope 58 is used as a detection instrument, similarly to detector 30 (FIG. 1A). Light source 28 transmits light beam 66 through light source filter 62. Light source filter 62 may be positioned anywhere along its transmission path until it impinges on biomaterial 56. Thus light source filter 62 may be adjacent to light source 28, may be positioned closer to DM 60 (as shown) or may be positioned between DM 60 and solution 54. If light beam 66 has a wide spectral range, then light source filter 62 may be positioned adjacent to light source 28 to avoid the escape of any unfiltered light towards the solution. DM 60 diverts and/or reflects light beam 66 towards container 52, shown as a light beam 68. Light beam 68 impinges on biomaterial 56 and excites the emission of a light beam 70. As shown, light beams 68 and 70 have different wavelengths (shown as different types of lines and arrows in FIG. 1B) as that is the nature of fluorescence emitted from a biomaterial which has absorbed a light beam. When light beam 70 impinges on DM 60, DM 60 allows light beam 70 to pass through DM 60 unchanged, however as shown, light beam 66 was deflected by DM 60 as light beam 68 towards biomaterial 56. This is due to the different wavelengths of light beams 68 and 70, as DM 60 selectively allows only certain wavelengths to pass there through. DM 60 will thus allow light beam 70 to pass there through unchanged, however light beam 66, or any reflections from light beam 68 (such as reflections from the upper surface of solution 54) will not be passed through DM 60. Thus, light beam 70 continues to travel towards microscope 58, passing through microscope filter 64 on its way. Microscope filter 64 may be adjacent to microscope 58, may be positioned closer to DM 60 or may be positioned between solution 54 and DM 60 along the path of light beam 70. In the configuration presented in FIG. 1B, light beam 66 is perpendicular with respect to the surface of solution 54 in which biomaterial 56 is submerged. Light source filter 62 and microscope filter 64 may be bandpass (herein abbreviated BP) filters. Light source filter 62 is designed to pass only those wavelengths of light source 28 that differ from wavelengths emitted by biomaterial 56, whereas microscope filter 64 is designed to pass only wavelengths corresponding to wavelengths emitted by biomaterial 56. All this is done in order to minimize the arrival of stray light originating directly from light source 28 to microscope 58. DM 60 may be embodied as a filter designed to pass only those wavelengths emitted from biomaterial 56 and thus may be a BP filter with respect to light beam 70. It is noted that in both the setups of FIGS. 1A and 1B, the biomaterial may be added to a solution or mixed with a solution for the purpose of detection.

Systems and methods for fluorescence-based detection of biological and biochemical reactions (i.e., fluorescent markers present in biomaterials) are known in the art. An article entitled “On-chip Fourier Transform Spectrometer for Chemical Sensing Applications” to Zheng et al., published in the conference on lasers and electro-optics (CLEO), 2016, is directed to an on-chip Fourier transform spectrometer (FTS) which exploits a tunable Mach-Zehnder interferometer (MZI) by taking advantage of a thermo-optic effect for achieving a high resolution. The FTS is fabricated using a nano-silicon-photonic fabrication process. One arm of the MZI is tuned using a micro-heater such that a large optical path difference between the two arms can be generated to realize an FTS with a broadband of at least 150 nm and a resolution of at least 40 cm⁻¹.

An article entitled “On-chip Fourier transform spectrometer on silicon-on-sapphire” to Heidari et al., published in Optics Letters, Vol. 44, No. 11 by the Optical Society of America, on Jun. 1, 2019, pp. 2883-2886, is directed to an on-chip Fourier transform spectrometer implemented using silicon-on-sapphire. The spectrometer comprises an array of Mach-Zehnder interferometers with linearly increasing optical path delays between their arms. A propagation loss of 5.2 dB/cm has been experimentally observed for strip waveguides and a resolution better than 10 cm⁻¹ has been achieved. The article discloses that the resolution can be improved either by increasing the integration density or by employing slow light effects.

An article entitled “Optical and Electrical Interfacing Technologies for Living Cell Bio-Chips” to Shacham-Diamand et al., published in Current Pharmaceutical Biotechnology, 2010, Vol. 11, No. 4 by Bentham Science Publishers Ltd., pp. 1-8, is directed to whole-cell biochips that integrate living cells on miniaturized platforms made by micro-system technologies. The cells are integrated, deposited or immersed in a media which is in contact with the chip for functional sensing. A front end unit detects the cell response and the resultant signal is analyzed and stored for further processing.

An article entitled “CMOS image sensor integrated with micro-LED and multielectrode arrays for the patterned photostimulation and multichannel recording of neuronal tissue” to Nakajima et al., published in Optics Express, 2012, Vol. 20, No. 6, by Optical Society of America, on Feb. 29, 2012, pp. 6097-6108, is directed to a complementary metal oxide semiconductor (CMOS) integrated device for optogenetic applications. The device may interface via neuronal tissue with three functional modalities: imaging, optical stimulation and electrical recording.

Other prior art in this field includes US patent application publication numbers US 2014/0152801 A1, US 2017/0176255 A1 and US 2020/0290043 A1.

As mentioned above, fluorescence can also be used to determine at least a portion of the constituents of a polymer. This can be achieved through the use of biosensors involving nanopores wherein a fluorescent substance is induced to move through a nanopore that is illuminated by a light source. Given that nanopores may have a diameter as small as a few nanometers, polymers containing fluorescent sections can be threaded through a nanopore enabling different sections of the polymer to be illuminated as the polymer passes through the nanopore. As different sections of the polymer may be constituted of different monomers, a different fluorescent response can be expected over time (as per the different monomers in the polymer) as the polymer moves through the nanopore, thus enabling at least a portion of the sequence of the polymer to be determined based on the emitted fluorescence over time.

An example of such a biosensor can be found in US patent application publication no. 2021/0003547 A1, to Meller et al., entitled “Light-Enhancing Plasmonic Nanowell-Nanopore Biosensor and Use Thereof”. The system of Meller is directed to a biosensor for detecting fluorescence from a molecule and comprises an ion-impermeable film comprising at least one ion-conducting nanopore. An upper liquid reservoir and a lower liquid reservoir are separated by the film. Electrodes coupled with the upper and lower liquid reservoirs are used as a means to induce movement of the molecule from the upper reservoir to the lower reservoir via the nanopore. The system of Meller includes a light source capable of exciting the molecule to emit fluorescence, wherein the light source shines into the lower reservoir. A metallic layer adhered to the film by an adhesion layer is also included and comprises a nanowell structure located adjacent to the nanopore. The system of Meller further includes a detector for detecting the fluorescence emitted by the molecule.

Even though polymers containing fluorescent sections can be threaded through nanopores that have a diameter as small as a few nanometers, the light used to illuminate the polymers has a diffraction limit which is at least one order of magnitude (if not two orders of magnitude) larger than the nanopore, which is the area and volume in a biosensor to be illuminated. Visible light, which is used in biosensors for illuminating polymers to give off fluorescence for the purposes of detection, has a diffraction limit on the order of hundreds of nanometers, which is significantly larger than the diameter of a nanopore through which polymers of interest are threaded through. Known biosensors thus exhibit significant energy loss regarding the amount of energy from emitted visible light which actually interacts with a polymer of interest for emitting fluorescence.

### SUMMARY OF THE DISCLOSED TECHNIQUE

It is an object of the disclosed technique to provide novel methods and systems for fluorescence-based detection which overcome the disadvantages of the prior art. In accordance with an aspect of the disclosed technique, there is thus provided a device for fluorescence-based detection of at least one polymer. The device includes at least one container, at least one light source, at least one detector and at least one first optical element. The container includes a nanopore membrane and a waveguide layer. The nanopore membrane includes at least one nanopore and the waveguide layer includes at least one first opening. The light source is optically coupled with the waveguide layer and is for generating at least one light beam for illuminating the polymer. The detector is for detecting at least one emission emitted from the illuminated polymer and the first optical element is for entering the light beam into the waveguide layer. The first opening is positioned substantially in line with the nanopore and the polymer is placed within a solution within the container. The polymer is illuminated by the light beam propagating through the waveguide layer through the first opening and the illuminated polymer emits the emission as it passes through the nanopore and the first opening.

In accordance with another aspect of the disclosed technique, there is thus provided a device for fluorescence-based detection of at least one polymer. The device includes at least one container, at least one light source, at least one detector and at least one optical element. The container includes a nanopore membrane and an electromagnetic (EM) concentration layer. The nanopore membrane includes at least one nanopore and the EM concentration layer includes at least one opening. The EM concentration layer is deposited adjacent to the nanopore membrane. The light source is for illuminating the polymer with the light beam and the detector is for detecting at least one emission emitted from the illuminated polymer. The optical element is positioned between the substrate and at least one of the light source and the detector. The optical element is for at least one of focusing the light beam to the opening and directing the emission towards the detector. The opening is positioned substantially in line with the nanopore, the polymer is placed within a solution within the container and the illuminated polymer emits the emission as it passes through the nanopore.

In accordance with a further aspect of the disclosed technique, there is thus provided a device for fluorescence-based detection of at least one biomaterial. The device includes at least one light source, a substrate, at least one detector, at least one respective detector filter and at least one waveguide. The detector is embedded in the substrate, the respective detector filter is positioned above the substrate and respectively over the detector and the waveguide is positioned above the respective detector filter and optically coupled with the light source. The light source is for illuminating the biomaterial with at least one light beam and the detector is for detecting at least one emission emitted from the illuminated biomaterial. The respective detector filter is for filtering the emission and the waveguide is for guiding the light beam from the light source to the biomaterial. The waveguide includes an upper cladding layer, a core and a lower cladding layer. The upper cladding includes at least one thin portion forming at least one respective container. The light beam is guided to the respective container through the core and then through the thin portion to the respective container. The biomaterial is placed within the respective container and the detector is positioned outside a direct line-of-sight (LOS) of the light source.

In accordance with another aspect of the disclosed technique, there is thus provided a device for fluorescence-based detection of at least one biomaterial. The device includes at least one base, at least one substrate, at least one light source, at least one detector and at least one optical element. The base includes at least one container. The substrate is coupled with the base and the light source is positioned above the substrate. The detector is respectively embedded in the substrate and the optical element is positioned below the base and below the substrate. The optical element includes a one-sided reflective coating. The light source is for illuminating the biomaterial and the detector is for indirectly detecting at least one emission emitted from the illuminated biomaterial. The biomaterial is placed within a solution within the container and the detector is positioned outside a line-of-sight (LOS) of the emission emitted from the illuminated biomaterial from within the container. The one-sided reflective coating is for reflecting the emission emitted from the illuminated biomaterial towards the detector. The optical element includes the one-sided reflective coating and enables the emission emitted from the illuminated biomaterial to pass through the optical element twice before being detected by the detector.

In accordance with a further aspect of the disclosed technique, there is thus provided a device for fluorescence-based detection of at least one biomaterial. The device includes a substrate, at least one light source, at least one filter and at least one detector. The substrate includes at least one container and at least one base. The light source is positioned above the substrate and the filter is positioned between the container and the base. The detector is encapsulated within the base. The light source is for illuminating the biomaterial and the detector is for detecting at least one emission emitted from the illuminated biomaterial. The biomaterial is placed within a solution within the container and the detector is positioned proximate to the container and outside a direct line-of-sight (LOS) of the light source.

### BRIEF DESCRIPTION OF THE DRAWINGS

The disclosed technique will be understood and appreciated more fully from the following detailed description taken in conjunction with the drawings in which:

FIG. 1A is a schematic illustration of the prior art;

FIG. 1B is a schematic illustration of the prior art;

FIG. 2 is a schematic illustration of a first fluorescence-based detection system, constructed and operative in accordance with an embodiment of the disclosed technique;

FIG. 3 is a schematic illustration of a second fluorescence-based detection system, constructed and operative in accordance with another embodiment of the disclosed technique;

FIGS. 4A and 4B are schematic illustrations of a third fluorescence-based detection system, constructed and operative in accordance with a further embodiment of the disclosed technique embodiment;

FIG. 5 is a schematic top view illustration showing a chip including a plurality of containers for use with embodiments of the disclosed technique, constructed and operative in accordance with another embodiment of the disclosed technique;

FIG. 6 is a schematic illustration of a fourth fluorescence-based detection system using a backlight and waveguides, constructed and operative in accordance with a further embodiment of the disclosed technique;

FIG. 7 is a schematic illustration of the fourth fluorescence-based detection system of FIG. 6 used to illuminate a plurality of containers, constructed and operative in accordance with another embodiment of the disclosed technique;

FIG. 8 is a schematic illustration of a fifth fluorescence-based detection system including a plurality of independent waveguides, constructed and operative in accordance with a further embodiment of the disclosed technique;

FIG. 9 is a schematic illustration of a sixth fluorescence-based detection system using waveguides with a sub-wavelength deformation zone, constructed and operative in accordance with another embodiment of the disclosed technique;

FIG. 10 is a schematic illustration of a seventh fluorescence-based detection system using waveguides with an embedded light source, constructed and operative in accordance with a further embodiment of the disclosed technique;

FIG. 11 is a schematic illustration of a magnified view of a waveguide as used in a fluorescence-based detection system, constructed and operative in accordance with another embodiment of the disclosed technique;

FIG. 12 is another schematic illustration of the seventh fluorescence-based detection system using waveguides with an embedded light source for multi-wavelength excitation, constructed and operative in accordance with a further embodiment of the disclosed technique;

FIG. 13 is a schematic illustration of an eighth fluorescence-based detection system, constructed and operative in accordance with another embodiment of the disclosed technique;

FIG. 14 is a schematic illustration of a first configuration of a fluorescence-based detection system using nanopores, constructed and operative in accordance with a further embodiment of the disclosed technique;

FIG. 15 is a schematic illustration of a first arrangement of the EM concentration layer of the fluorescence-based detection system using nanopores of FIG. 14, constructed and operative in accordance with another embodiment of the disclosed technique;

FIG. 16 is a schematic illustration of a second arrangement of the EM concentration layer of the fluorescence-based detection system using nanopores of FIG. 14, constructed and operative in accordance with a further embodiment of the disclosed technique;

FIG. 17 is a schematic illustration of a third arrangement of the EM concentration layer of the fluorescence-based detection system using nanopores of FIG. 14, constructed and operative in accordance with another embodiment of the disclosed technique;

FIG. 18 is a schematic illustration of a second configuration of a fluorescence-based detection system using nanopores and waveguides, constructed and operative in accordance with a further embodiment of the disclosed technique;

FIG. 19 is a schematic illustration of a first arrangement of the waveguides of the fluorescence-based detection system using nanopores and waveguides of FIG. 18, constructed and operative in accordance with another embodiment of the disclosed technique;

FIG. 20 is a schematic illustration of a second arrangement of the waveguides of the fluorescence-based detection system using nanopores and waveguides of FIG. 18, constructed and operative in accordance with a further embodiment of the disclosed technique;

FIG. 21 is a schematic illustration of a third arrangement of the waveguides of the fluorescence-based detection system using nanopores and waveguides of FIG. 18, constructed and operative in accordance with another embodiment of the disclosed technique; and

FIG. 22 is a schematic illustration of a fourth arrangement of the EM concentration layer of the fluorescence-based detection system using nanopores of FIG. 14, constructed and operative in accordance with a further embodiment of the disclosed technique.

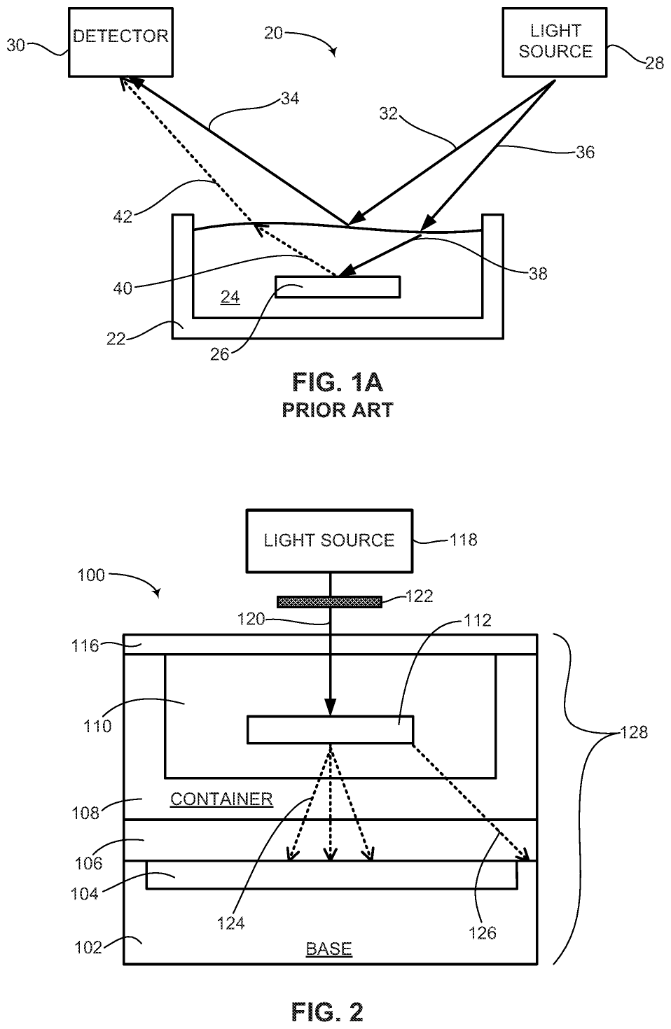

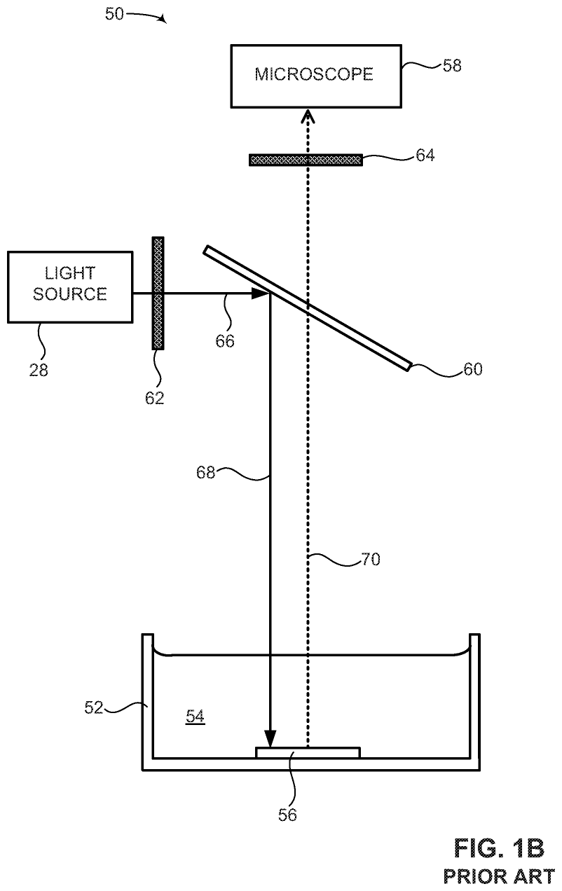

### DETAILED DESCRIPTION OF THE EMBODIMENTS

The disclosed technique overcomes the disadvantages of the prior art by providing novel systems and methods for detecting and identifying biological and biochemical reactions utilizing fluorescence-based detection. The disclose technique also provides for novel systems and methods for sequencing polymers and identifying at least a portion of their constituent molecules utilizing fluorescence-based detection and analysis. The novel systems and methods of the disclosed technique can detect the presence of at least one fluorescent marker in a biomaterial. The novel systems and methods utilize semiconductor substrate constructions embedded with waveguides, optical filters and light detectors, thus enabling a significantly high signal-to-noise ratio (herein abbreviated SNR) of any emitted fluorescence from a biomaterial. The disclosed technique also enables increased flexibility in the construction of the detection system, a decrease in the physical size of the system (and consequently a decrease in the required amount of biological material needed for a sample) as well as a simplification in construction and manufacturing. As explained above, prior art fluorescent-based detection systems exhibit significant energy loss in that most of the emitted energy of illuminating light beams is not used to generate fluorescence in a polymer or biomaterial of interest due to the diffraction limit of visible light as compared to the size of a nanopore. In addition, the light beams which are not used to illuminate the polymer or biomaterial of interest can become a source of noise in the detector detecting the fluorescence from the polymer or biomaterial, as those unused light beams may create unwanted fluorescence from other sources in and around the fluorescence-based detection system. The disclosed technique thus further includes semiconductor substrate constructions having at least one nanopore wherein electromagnetic (herein abbreviated EM) radiation can be concentrated around the at least one nanopore. These constructions can include either at least one EM radiation concentration layer, at least one dielectric layer or both for mitigating the energy loss of the illuminated light beams. The EM concentration layer of the disclosed technique focuses and attracts Illuminated light beams towards the nanopore while also acting as a shield for preventing stray light from reaching a detector meant to detect fluorescence specifically from a polymer or biomaterial passing through the nanopore. The dielectric layer of the disclosed technique enables light beams having a diffraction limit in the hundreds of nanometers to be focused and concentrated into a waveguide layer, wherein a significant portion of the energy of the illuminated light beams can be brought precisely to the nanopore, regardless of its small size as compared to the diffraction limit of visible light. These constructions can also include at least one waveguide for guiding light precisely to the vicinity of the nanopore, thus also enabling a significantly high SNR of any emitted fluorescence from a polymer threaded through the nanopore for sequencing at least a portion of the molecular constituents of the polymer.

Biomaterials in the context of the disclosed technique are materials or samples that are produced from and/or interact with any organism or living thing that may have natural fluorescence. For example, since certain human body fluids are fluorescent, the use of fluorescence offers a unique method for locating them and/or identifying their presence in the body. Other biological molecules and compounds which are not naturally fluorescent can be chemically linked with fluorescent molecules to become fluorescent and thus the use of biomaterials in the context of the disclosed technique includes such biological molecules and compounds as well. In general, the terms “light” and “radiation” are used in the following manner throughout the description to describe the disclosed technique. “Light” is used to refer to electromagnetic radiation which is emitted towards a biomaterial whereas “radiation” is used to refer to electromagnetic radiation which is emitted from the biomaterial via the interaction of the biomaterial with the light. As described above, light which is emitted towards a biomaterial will have a different wavelength than radiation which is emitted from a biomaterial as fluorescence. This is due to the physics of how fluorescence is described. In addition, the term “container” is used throughout the description to describe the volume in the disclosed technique wherein a biomaterial and/or polymer to be illuminated for fluorescence is placed. The container usually includes a solution. In the case of polymer sequencing the solution may be ionic, thus containing charge carriers. The container is thus also the reaction chamber where transmitted light interacts with a biomaterial and may result in fluorescence. Thus the terms “container” and “reaction chamber” are used interchangeably throughout the description of the disclosed technique to describe the same physical space of where the biomaterial is placed in a solution. It is further noted that the description refers to biomaterials in general which are organic, however the disclosed technique can equally be used to detect fluorescence in both organic and inorganic compounds. Organic compounds can include proteins, polypeptides, DNA, RNA, lipids and the like whereas inorganic compounds can include inorganic polymers of various sorts.

Reference is now made to FIG. 2, which is a schematic illustration of a first embodiment of a fluorescence-based detection system, generally referenced 100, constructed and operative in accordance with an embodiment of the disclosed technique. Detection system 100 may serve as a platform for the promotion, the execution and the detection of biological and/or biochemical reactions on a substrate, which may be a semiconductor. According to a first embodiment, detection system 100 includes an encapsulated photodetector with filter. Detection system 100 as shown includes a base 102, which may be a silicon substrate or any other semiconductor substrate, a photodetector 104, a physical filter 106, a container 108, a solution 110, a biomaterial 112, a cover 116, a light source 118, a light beam 120 and a light source filter 122. Shown as well is an emitted radiation 124 and a peripheral radiation 126. The structural components of detection system 100 can be constructed on a chip 128 thereby including base 102, photodetector 104, physical filter 106, container 108 and cover 116. Solution 110 and biomaterial 112 can be placed in container 108. Solution 110 may fill the entirety of container 108. Alternatively (not shown), there may be an air gap between solution 110 and cover 116.

It is noted that FIG. 2 shows only a single container 108 within detection system 100 for the purposes of clarity, however it is clear to the worker skilled in the art that detection system 100 may be comprised of a plurality of containers (not shown) under which are placed respective photodetectors (also not shown) for detecting emitted radiation from a biomaterial placed within each container. Whereas not illustrated in FIG. 2, a single cover 116, a single light source 118, a single physical filter 106 and a single base 102 may be used for a plurality of containers and photodetectors.

As mentioned above, FIG. 2 discloses an encapsulated photodetector with a physical filter which is embedded in the structure of chip 128. Thus according to the disclosed technique, the macroscopic detection systems of the prior art are replaced with a miniaturized system packaged and manufactured such that most components of the detection system (minus the light source) are placed within a single chip. Other embodiments of the disclosed technique wherein all components of the detection system are placed within a single chip design are described below.

According to the present invention, light source 118 emits light beam 120 through light source filter 122. Light beam 120 is in general a continuous light beam, however light beam 120 can also be a pulsed light beam. Light beam 120 passes through cover 116, which is transparent, passing through solution 110 and eventually exciting biomaterial 112. Light beam 120 is absorbed by biomaterial 112 which then emits radiation in various directions (e.g., emitted radiation 124 and peripheral radiation 126). Emitted radiation 124 passes through physical filter 106 and then impinges on photodetector 104. Photodetector 104 may be coupled with a processor (not shown) for recording detected fluorescence from biomaterial 112. Peripheral radiation 126 which passes through physical filter 106 yet does not impinge on photodetector 104 is thus not taken into account for detection purposes. Light source 118 may be embodied as an in-package light emitting diode (herein abbreviated LED) or as a laser diode. The structure of detection system 100 enables both a physical filter and a photodetector to be positioned substantially close to the biomaterial thus increasing the SNR of emitted radiation 124 on photodetector 104 and preventing any stray light and/or peripheral radiation from impinging on photodetector 104.

Detection system 100 as shown in FIG. 2 uses an external illuminator (such as an LED) illuminating all the reaction chambers on the chip, shown as light source 118. The photodetector itself is encapsulated and positioned under the reaction chamber (i.e., container 108), which positions it very close to the biochemical reaction occurring in biomaterial 112 interacting with emitted light beam 120 and enables photodetector 104 to collect close to 50% of the fluorescence emitted from biomaterial 112 in container 108. The photodetector area and size may also substantially match the area and size of the container, thus minimizing dark areas in the photodetector which might otherwise contribute to noise and loss of signal. It is noted that container 108 should be made from a material which is at least transparent to the wavelengths of emitted radiation 124.

Photodetector 104 can be embodied for example as a photodiode and can be manufactured via known commercial processes in a variety of shapes, either laterally (such as a PIN type diode) or vertically. Photodetector 104 can also be embodied as an avalanche photodiode (herein abbreviated APD). Physical filter 106 may be embodied as any kind of physical filter which filters radiation based on an interaction of its physical structure and dimensions with photons (i.e., from the radiation). In general, physical filter 106 is an optical filter, which as shown is placed between the silicon substrate and the container. Physical filter 106 serves to discriminate the light emitted from light source 118 from the radiation emitted by biomaterial 112. Physical filter 106 may in general be embodied as either an interference filter or as a grating filter. Embodied as an interference filter, physical filter 106 can be constructed by depositing thin layers of a dielectric material which is compatible with the material of base 102 and with the general chip manufacturing technology used to assemble chip 128. Embodied as a grating filter, physical filter 106 can be constructed by lateral lithography which is applied during the process of manufacturing chip 128. It is noted as well that physical filter 106 can also be a combination of both an interference filter and a grating filter (not shown). As described and mentioned below, chemical filters, such as dye filters, can be used with the disclosed technique as additional filters to physical filter 106 when light source 118 emits light at different wavelengths (and thus at different colors) consequently or simultaneously. It is noted that light source filter 122 also serves the purpose of preventing ambient or stray light from entering solution 110, thus ensuring that only light from light source 118 impinges on biomaterial 112 as light beam 120.

As mentioned above, physical filter 106 maybe implemented according to a number of different embodiments. In one embodiment, physical filter 106 may be an interference filter, constructed from several layers of transparent materials with different thicknesses and different dielectric constants. In a second embodiment, physical filter 106 may be a grating filter. As described below as well, in certain embodiments of the disclosed technique, an addition filter (not shown) may be used with physical filter 106, The addition filter may be a pigment/dye filter, which is compatible with available commercial processes and consists of a thin optically selective layer.

In another embodiment of the disclosed technique, detection system 100 is constructed without physical filter 106, and the filtering aspect of the detection system is achieved by a method of time division duplex (herein abbreviated TDD) filtering. In such a method, the time domain is used to separate and filter excitation and emitted fluorescence as radiation from light originating from the light source. In this embodiment of the disclosed technique, the light source and the photodetector are embodied as fast switching devices (on the order of gigahertz), since the lifetime of fluorescence may be as short as 1-3 nanoseconds. In TDD filtering, the photodetector is synchronized to only absorb radiation at particular time intervals following the transmission of light from the light source, thus effectively only absorbing emitted radiation from the biomaterial and not from the light source. In addition, in TDD filtering, the light source emits light pulses as opposed to a continuous beam of light. For example, it is thus possible, according to the disclosed technique, for light source 118 to excite molecules in biomaterial 112 with short light pulses (ranging from a few picoseconds up to about ˜1 nanosecond in duration), followed by a few nanoseconds when light source 118 does not emit any light, during which photodetector 104 absorbs emitted radiation from biomaterial 112. In this example, photodetector 104 may not have a gate or shutter and may always be absorbing radiation, however the processor or amplifier (both not shown) to which the photodetector is coupled with may selectively register detected radiation at specific time intervals, thus effectively only registering absorbed radiation emitted from the biomaterial. According to another example, the photodetector may include an electronic gate or shutter, such that when light source 118 transmits light to biomaterial 112, the electronic gate of photodetector 104 is closed, and after a sufficient delay for biomaterial 112 to absorb light beam 120, the electronic gate of photodetector 104 is then opened for a number of nanoseconds to absorb any emitted radiation from biomaterial 112. The photodetector can thus be electronically gated to observe fluorescence from the biomaterial in the following few nanoseconds after light is transmitted from light source 118. The TDD mode of filtering requires that the optical devices of detection system 100 (such as light source 118 and photodetector 104) operate at a frequency of approximately 1 gigahertz. As mentioned above, in this embodiment, physical filter 106 is not necessary and may either be eliminated or may be kept to provide additional filtering. Thus in a further embodiment of the disclosed technique, physical filter 106 may be used while also employing TDD filtering to improve the discrimination of physical filter 106. In general, TDD filtering can be used with any optical filter to improve its discrimination. TDD filtering can provide some lock-in noise gain, as timed gating is used to prevent photodetector 104 from receiving noise signals as opposed to emitted radiation 124. In general, the timing of when photodetector 104 either records absorbed radiation or when the electronic gate or shutter of the photodetector is open can be determined through a learning process of when a particular biomaterial emits radiation after absorbing transmitted light. Thus photodetector 104 can be locked onto the emission of photons emerging from biomaterial 112 as emitted radiation 124 and will only receive the desired fluorescence from biomaterial 112.

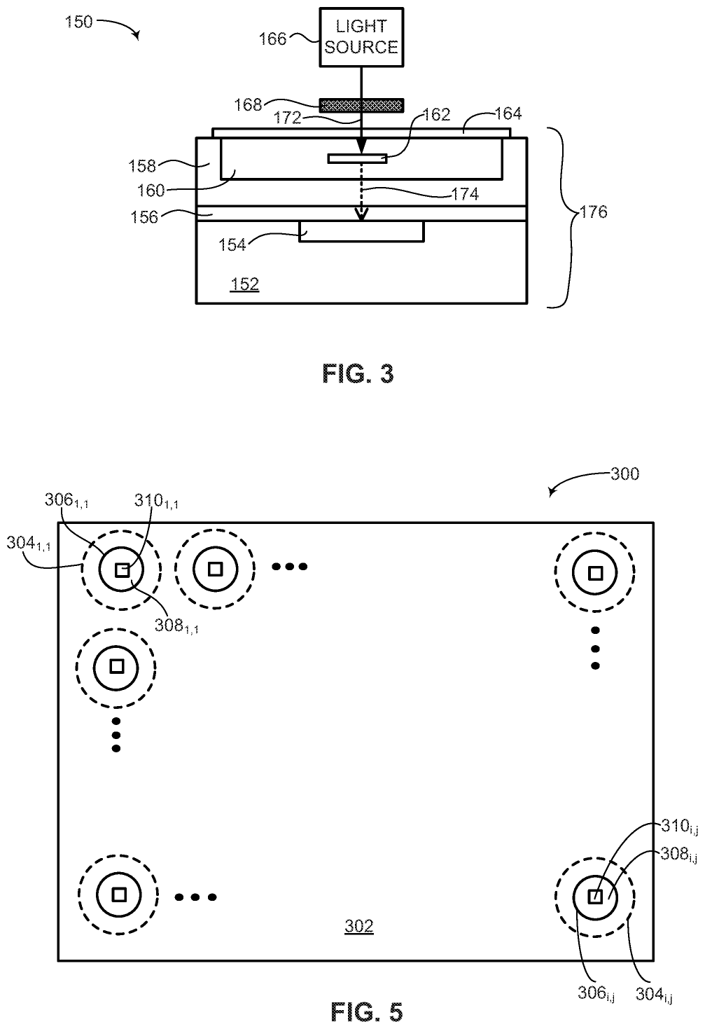

Reference is now made to FIG. 3, which is a schematic illustration of a second fluorescence-based detection system, generally referenced 150, constructed and operative in accordance with another embodiment of the disclosed technique. The detection system of FIG. 3 is similar to that of FIG. 2, however the construction described in FIG. 3 splits the detection system into two separate chips where one chip includes the containers (i.e., the reaction chambers) and the other chip contains the photodetectors. The detection systems of FIGS. 2 and 3 and in general, for many of the embodiments of the disclosed technique as described herein, are shown having a single container and a single photodetector. This is merely for illustrative purposes. The detection systems of the disclosed technique can be embodied having a plurality of containers along with a respective plurality of photodetectors. In the embodiment of FIG. 3, the two chips are separated by an optical filter (i.e., a physical filter) which is an independent component and thus easier to fabricate. The two chips may be packaged together by commercially available technologies such as silicon-on-silicon and/or by soldering or gluing, with alignment accuracies of the order of ±1 micrometer, thus enabling alignment between the photodetector and the container and maintaining the capability to collect most of the emitted radiation from the biomaterial. The filter itself may be glued into its position and the light source can be part of the package (as an external element) as showed above in FIG. 2.

As shown in FIG. 3, a light source 166 sends a light beam 172 through a light source filter 168. Light beam 172 penetrates through a transparent cover 164 and impinges on a biomaterial 162, which is positioned in a solution 160. Solution 160 is located in a container 158 that is separated from a base 152 by a physical filter 156. Base 152 may be made of silicon or other suitable semiconductor material. Base 152 comprises an embedded photodetector 154, such that emitted radiation 174 reaches photodetector 154 when biomaterial 162 is excited by light beam 172. Thus base 152 along with photodetector 154 can be manufactured as a first single chip whereas container 158 can be manufactured as a second single chip. In this embodiment, the two chips can be assembled together with physical filter 156 to form a single chip. Thus base 152 together with photodetector 154, physical filter 156, container 158, solution 160, biomaterial 162 and cover 164, once assembled together, may be considered a chip 176. Light source 166 may be an in-package LED.

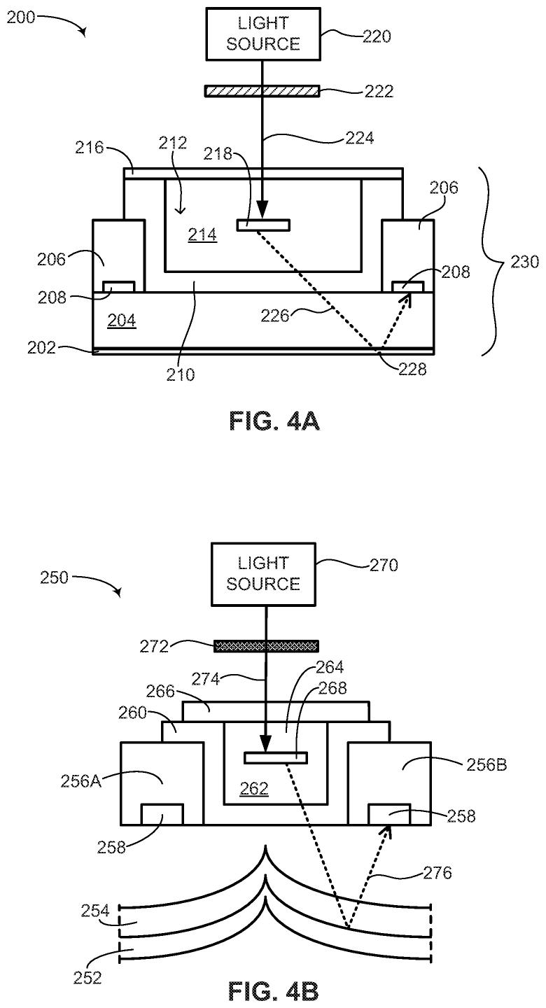

Reference is now made to FIGS. 4A and 4B, which are schematic illustrations of a third fluorescence-based detection system, generally referenced 200 and 250 respectively, constructed and operative in accordance with a further embodiment of the disclosed technique. With reference to FIG. 4A, depicted is an assembly 230 in which the emitted radiation from a biomaterial is reflected within the assembly towards a plurality of detectors (i.e., plurality of photodetectors 208) via a reflective coating lining the inside of the assembly instead of traveling directly from the biomaterial to the photodetectors, as shown in the embodiments of the disclosed technique shown above in FIGS. 2 and 3.

The construction of the assembly in FIG. 4A eliminates the need to separate the detector chip by adding mirroring capabilities to the physical filter (e.g., by a metal coating, or by a dielectric layer and using the principle of total internal reflection (herein abbreviated TIR)), as described below. This structure has a slight disadvantage in that it is harder to capture the fluorescence emitted by the biomaterial in the photodetectors, however the disadvantage can be overcome by shaping the mirror to maximize light reflection towards the photodetectors, according to the disclosed technique. In addition, this structure has an advantage over other embodiments of the disclosed technique in that emitted radiation passes through the physical filter twice, thereby improving filtering performances and enhancing the SNR of the received emitted radiation in the photodetectors. Also the filter can be manufactured on top of the substrate as a secondary process, thus keeping the manufacturing cost of this embodiment close to that of the embedded physical filter embodiments shown above in FIGS. 2 and 3.

A one-sided reflective coating 202 is attached to a physical filter 204, which is attached both to a plurality of substrates 206 and a base 210. Each one of substrates 206 may be comprised of silicon, whereas base 210 may be comprised of SiO₂ (silicon dioxide) to allow light to pass through that material. A first one of plurality of substrates 206 is attached at a first end of base 210 and whereas a second one of plurality of substrates 206 is attached at a second end of base 210. A cavity 212 located in the middle of base 210 forms a container in which a solution 214 is placed and which is closed with a cover 216. A biomaterial 218 is placed inside cavity 212 with solution 214. A light source 220 may be an in-package LED. Light source 220 emits a light beam 224 through a light source filter 222. Light beam 224 impinges on biomaterial 218, which then emits a radiation beam 226. Radiation beam 226 is filtered a first time by physical filter 204 on its way towards reflective coating 202, which diverts beam 226 towards one of photodetectors 208. On its way towards one of photodetectors 208, after reflecting at a point 228 (for example), radiation beam 226 passes through physical filter 204 a second time. The fact that radiation beam 226 is filtered twice in this embodiment improves the quality of the filtration. Radiation beam 226 merely represents one of many radiation beams emitted from biomaterial 218, which eventually reach one of photodetectors 208. Thus other radiation beams emitted in additional directions (not shown) are also possible and can also be detected by this embodiment. As mentioned above, physical filter 204 can be embodied for example as an interference filter, a grating filter or a combination of the two.

With reference to FIG. 4B, an improved structure which maximizes the amount of emitted radiation reaching the photodetectors is shown. The elements of FIG. 4B are substantially similar to the elements of FIG. 4A, however reflective coating 202 (FIG. 4A) has been replaced by a curved filter 254 along with a curved one-sided reflective coating 252. Curved filter 254 is attached on one side to curved one-sided reflective coating 252. Curved filter 254 is also attached to base 260 (not shown). Base 260 is attached to a first substrate 256A at a first end and to a second substrate 256B at a second end. Each one of substrates 256A and 256B has a respective photodetector 258 at one end. Each one of substrates 256A and 256B may be made from silicon, whereas base 260 may be made from SiO₂ (silicon dioxide) to allow light to pass through the material. A container 262 is located at the center of base 260. Container 262 may comprise a solution 264 in which a biomaterial 268 is placed. Container 262 is covered by a cover 266. A light source 270 may be an in-package LED. Light source 270 sends an emitted light beam 274 through a light source filter 272. Light beam 274 impinges on biomaterial 268, which emits a radiation beam 276. Radiation beam 276 is filtered twice by curved filter 254. Radiation beam 276 is reflected by curved one-sided reflective coating 252 towards one of photodetectors 258. The curved reflective coating and the curved filter together increase the amount of emitted radiation beam 276 that impinges upon the photodetector as compared to the flat reflective coating of FIG. 4A.

Reference is now made to FIG. 5, which is a schematic top view illustration showing a chip, including a plurality of containers, for use with embodiments of the disclosed technique, generally referenced 300, constructed and operative in accordance with another embodiment of the disclosed technique. FIG. 5 shows a top view of a chip including a plurality of containers (i.e., reaction chambers), all sharing a common light source, filters and mirror/mirrors (all not shown). Each container can be used to carry out an isolated biochemical reaction independent of neighboring and adjacent containers. FIG. 5 depicts a plurality of containers arranged in a matrix form on a silicon substrate 302.

As shown, each container in the matrix includes a photodetector 304_{i,j}. Within the area of each photodetector 304_{i,j}, a container 306_{i,j} is included therein that is substantially a cavity in the top layer or layers of the silicon substrate. For example, container 306_{i,j} may be an etched cavity in the chip's SiO₂ passivation layer (not shown). As shown, both photodetector 304_{i,j} and container 306_{i,j} may be shaped like concentric rings, with photodetector 304i,j (which is situated under the cavity) having a larger radius than container 306_{i,j}. The photodetectors are thus shown having dashed lines to indicate that they are located within silicon substrate 302 and situated under each respective container. Each container 306_{i,j} may be filled with a solution 308_{i,j} in which a biomaterial 310_{i,j} is placed. As mentioned, each container 306_{i,j} may function independently of the other containers. For example, each container 306_{i,j} may contain a different solution 308_{i,j} and/or a different biomaterial 310_{i,j}. According to one embodiment of the disclosed technique, data fusion can occur from the various containers 306_{i,j} according to a predefined algorithm. As shown in FIG. 5, on the top-left corner, an instance of photodetector 304_{i,j} is marked as photodetector 304_{1,1}, container 306_{i,j} is marked as container 306_{1,1}, solution 308_{i,j} is marked as solution 308_{1,1} and biomaterial 310_{i,j} is marked as biomaterial 310_{1,1}.

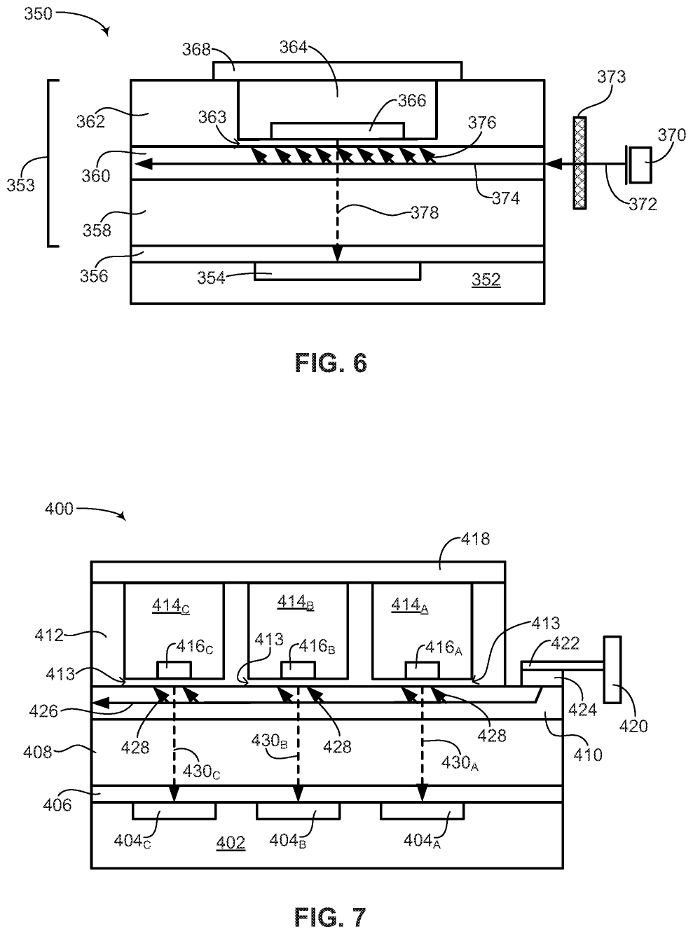

Reference is now made to FIG. 6, which is a schematic illustration of a fourth fluorescence-based detection system using a backlight and waveguides, generally referenced 350, constructed and operative in accordance with a further embodiment of the disclosed technique. The structure of FIG. 6 includes a side light which does not shine directly into the container containing the biomaterial nor potentially into the photodetector. The structure of FIG. 6 also includes light waveguides (also referred to as optical waveguides) for specifically delivering light beams to particular areas of the container. Thus the structure of FIG. 6 enables lighting only the active regions of the container, thereby reducing the amount of fluorescence reaching the photodetector which did not originate from the biomaterial. The side light is coupled with an optical waveguide on top of the substrate. The side light collimates light into the waveguides, for example by using edge excitation or by capturing light from the top surface using a coupler. The waveguide is designed to contain the light, for example using TIR (total internal reflection), thus only allowing light beams to leak out of and exit the waveguide where a biological sample and/or biomaterial of interest is positioned. The leaking out of and exiting of the light beams from the waveguide is controlled either by a sub-wavelength deformation of the waveguide at the place of the desired leak or by placing the container and the waveguide in such proximity such that different dielectric constants of the solution enable the leakage. As described below, the covering or cladding surrounding the waveguide can be thinned out in the areas surrounding the container, thereby breaking the TIR in the waveguide and allowing transmitted light to escape into the container.

As shown in FIG. 6, a silicon substrate 352 serves as a base for a photodetector 354. Attached to substrate 352 and photodetector 354, a physical filter 356 is positioned above substrate 352 and photodetector 354. A waveguide 353 is positioned above physical filter 356, wherein waveguide 353 includes a lower cladding layer 358, a core 360 and an upper cladding layer 362. Lower cladding layer 358 is positioned directly above physical filter 356 and may be made of SiO₂. Lower cladding layer 358 and upper cladding layer 362 substantially surround core 360. As shown, core 360 is located along a longitude axis of lower cladding layer 358 and upper cladding layer 362. Core 360 is made from a transparent dielectric material having a different dielectric constant as compared to the dielectric constants of upper and lower cladding layers 358 and 362. Core 360 is thus the light conducting core where light may be propagated underneath a container 364. Upper cladding layer 362 may include a container 364 which may include a solution (not labeled). A biomaterial 366 may be put inside container 364. Container 364 may be covered with a cover 368. A light source 370, which may be a laser diode or an LED, is coupled with core 360 at one end. Light source 370 may be an in-package collimated LED. When light source 370 is activated, a light beam 372 passes through a light source filter 373 and is focused into core 360 as a filtered light beam 374. As shown, upper cladding layer 362 has a thin portion 363 located under container 364. The thickness of thin portion 363 affects the conditions which allow for TIR in upper cladding layer 362, thereby allowing light beam 374 to escape and leak into container 364. The thickness of thin portion 363 may be on the order of nanometers, thus creating a “hole” In the TIR in core 360 and enabling light beam 374 to leak out into container 364. As light beam 374 propagates inside core 360 and arrives at thin portion 363, portions of light beam 374 split off into a plurality of light beams 376, which each exit core 360 and enter container 364, thus impinging biomaterial 366 at different locations along container 364. As shown, plurality of light beams 376 appear to show discrete areas where light beams escape from core 360 however in reality, light beams 376 escape through the entire thin portion under container 364 where the thickness of upper cladding layer 362 is altered. Biomaterial 366 reacts with plurality of light beams 376 and then emits radiation beam 378, which is collected by photodetector 354. As shown, light source 370 does not transmit light beam 372 directly onto photodetector 354. In addition, waveguide 353 and in particular core 360 allows light beam 374 to be propagated to and leaked at precise locations to the underside of container 364. According to the disclosed technique, the thickness of thin portion 363 can either be constant or can vary over distance, thus enabling an amount of control over how much of light beam 374 leaks into container 364. In one embodiment, the thickness of thin portion 363 may be zero (i.e., thin portion 363 is eliminated). In another embodiment, thin portion 363 may be 50 nanometers in thickness. In a further embodiment, thin portion 363 may have a variable thickness that ranges from 0 nanometers to 100 nanometers. The above numerical examples are merely examples to illustrate the disclosed technique. The variation in the thickness of thin portion 363 depends on the difference in dielectric constants between the cladding layer material and the core material and thus could in principle be even thicker than 100 nanometers.

Reference is now made to FIG. 7, which is a schematic illustration of the fourth fluorescence-based detection system of FIG. 6 used to illuminate a plurality of containers, generally referenced 400, constructed and operative in accordance with another embodiment of the disclosed technique. As mentioned above, edge excitation is also possible by using an optical fiber coupled with a laser diode that may be integrated in the package. In such a case, the light source filter may be placed conventionally on the laser diode side, or on the surface of the chip, as part of the coupling of the emitted light beam into the waveguide. As shown in FIG. 7, multiple containers can be excited by the same waveguide.

Silicon substrate 402 serves as a base for several photodetectors and several containers. It should be emphasized that other semiconductor materials (i.e., not just silicon) may be used for substrate 402. FIG. 7 shows three photodetectors 404_{A}, 404_{B} and 404_{C}, however other amounts of photodetectors are possible as well. A physical filter 406 is attached at one end to substrate 402 and to photodetectors 404_{A}-404_{C}, thus enabling a single physical filter to be used for a plurality of photodetectors. A lower cladding layer 408 is attached on one side to physical filter 406 and is part of a waveguide (not labeled) that includes a core 410 and an upper cladding layer 412. As shown, upper cladding layer 412 includes a plurality of containers 414_{A}-414_{C}. Shown as well, upper cladding layer 412 has a thin portion 413 under each respective one of plurality of containers 414_{A}-414_{C}. As mentioned above other numbers of containers are possible. A respective biomaterial 416_{A}-416_{C} may be placed in each container together with a solution (not labeled), which might be unnecessary in certain cases, depending on the type of the biomaterial under observation. In FIG. 7, three biomaterials are depicted, with biomaterial 416_{A} placed in container 414_{A}, biomaterial 416_{B} placed in container 414_{B} and biomaterial 416_{C} placed in container 414_{C}. As shown, it is possible to use a single cover 418 to cover all of containers 414_{A}-414_{C}. In an alternative embodiment, separate covers can be used for each individual container. A light source 420 sends light via an optical fiber 422 and a light source filter 424 which serves to couple the light into core 410. Light source 420 may be an LED, a laser or an in-package fiber-coupled laser diode. Via optical fiber 422 and light source filter 424, a light beam 426 is entered into core 410. Due to the change in thickness of thin portions 413, light beam 426 exits and leaks into each one of containers 414_{A}-414_{C} and respectively into biomaterials 416_{A}-416_{C}, shown as light beams 428 splitting off of light beam 426. Light beams 428 each respectively hit biomaterials 416_{A}-416_{C}, which each respectively emit in response radiation beams 430_{A}-430_{C}. Each biomaterial emits its own respective radiation beam, which is then received at the corresponding one of photodetectors 404_{A}-404_{C}. Other types of detectors (besides photodetectors) may also be embedded in substrate 402 (not shown).

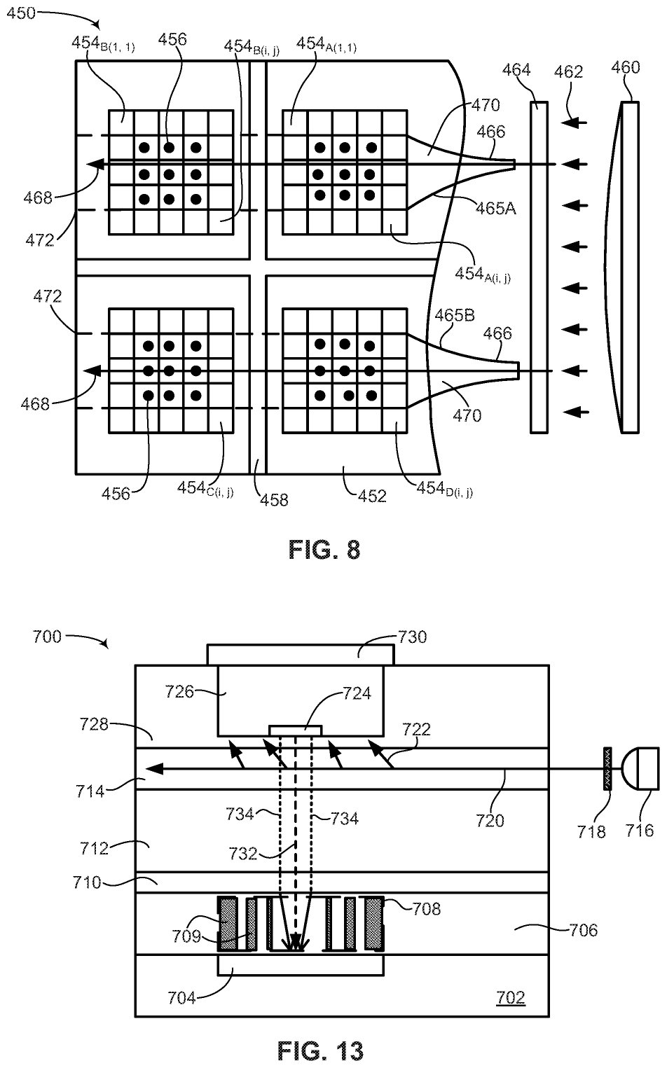

Reference is now made to FIG. 8, which is a schematic illustration of a fifth fluorescence-based detection system including a plurality of independent waveguides, generally referenced 450, constructed and operative in accordance with a further embodiment of the disclosed technique. FIG. 8 discloses a top view of a construction including a plurality of containers, excited by several independent waveguides. In the construction of FIG. 8, a plurality of photodetectors can be split into several independent photodetectors, where each one can be used to independently collect photons emitted as radiation from an excited biomaterial. This construction enables an optimization of the containers in which photodetectors managed to absorb radiation beams based on the exact position of the respective biomaterials in the reaction chambers. Each photodetector may have a different filter in front of it to facilitate a distinction between different wavelengths of emitted fluorescent radiation.

As shown, a single light source 460 may be an in-package collimated LED. Light source 460 emits a plurality of light beams 462 that are filtered by a common light source filter 464. The filtered light then enters two waveguides 465A and 465B in the general direction of a plurality of arrows 468. As shown, waveguides 465A and 465B may each include a respective tapering section 466 which allow each one of plurality of transmitted light beams 462 to expand into a plurality of wide light beams 470. Wide light beams 470 impinge on each one of biomaterial samples 456 placed inside containers (not shown) located within a silicon substrate 452 where a respective plurality of photodetectors (not specifically shown) are arranged in a plurality of matrices 454_{X(i,j)} respectively just below the containers. The plurality of matrices is separated from each other by a cross-shaped pattern 458, which can be shaped as a grid. Wide light beams 470 proceed to illuminate one matrix of photodetectors after another over the entire substrate 452 until reaching an end point 472. In the example depicted in FIG. 8, the matrix on the top-right corner is marked 454_{A}, the matrix on the top-left corner is marked 454_{B}, the matrix on the bottom-left corner is marked 454_{C} and the matrix on the bottom-right corner is marked 454_{D}. As an example, each matrix is shown as a 5×5 matrix, with each compartment of the matrix including an individual container and photodetector however other dimensions of matrices are possible as well. In each such matrix, biomaterial sample 456 is placed near its center where a solution (not labeled) is placed in the container (not labeled). Thus, in matrix 454_{A}, the member at the top-left corner is marked as 454_{A(1,1)}, whereas a general member of matrix 454_{A} is marked as 454_{A(i,j)}. Similarly, in matrix 454_{B}, the member at the top-left corner is marked as 454_{B(1,1)}; whereas a general member of matrix 454_{B} is marked as 454_{B(i,j)}. In matrix 454_{C} and in matrix 454_{D}, a general member is marked as 454_{C(i,j)} and 454_{D(i,j)}, respectively. In the embodiment shown in FIG. 8, a single emitted light beam can be used to illuminate a plurality of biomaterials in a plurality of containers placed in matrices positioned one after the other.

It is noted that respective tapering sections 466 can be used to change the mode of the light beams emitted from light source 460. For example, if light source 460 is a laser diode and transmits single mode laser light, respective tapering sections 466 can be designed to increase the single mode laser light to multi-mode laser light. Respective tapering sections 466 can also be designed to increase the single mode laser light to large mode area laser light. In general, the waveguides of the disclosed technique propagate single mode light, however the width of the waveguides can be changed, for example by using a tapering section, to allow for increased modes of light, such as multi-mode light or large mode area light. According to the disclosed technique, the width of the core of the waveguide can be designed to be different specifically under the container where an upper cladding layer has a thin portion, thereby enabling further modes of light beams to escape and leak out into the container when a biomaterial may be placed. By altering the width of the waveguide specifically under the container, the amount of light impinging on the biomaterial in the container can be changed. In general, according to the disclosed technique, the thickness of the thin portion under the container as well as the width of the core of the waveguide are optimized to get the desired amount of light escaping and leaking out of the core into the container where the biomaterial is situated.

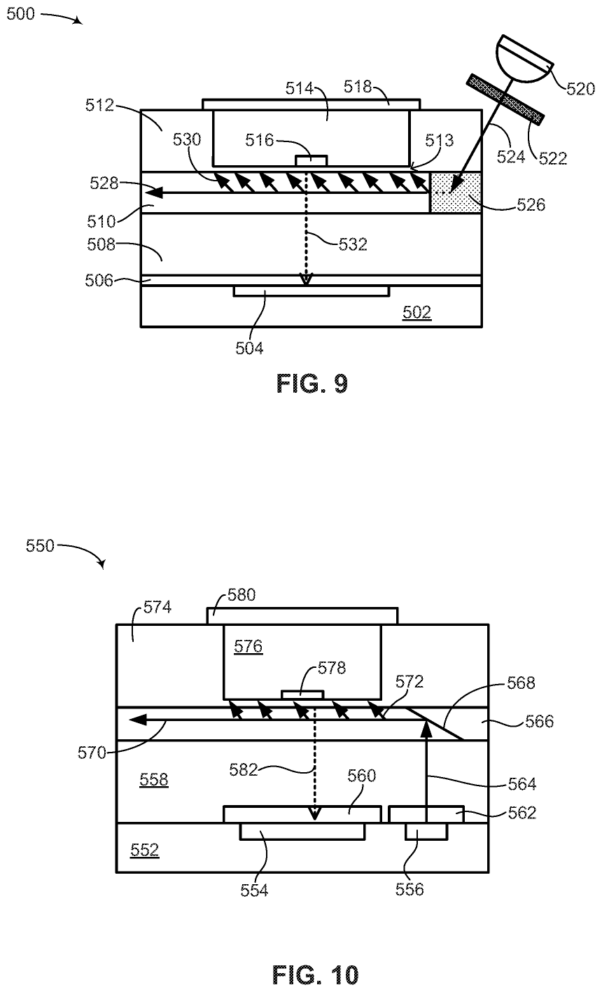

Reference is now made to FIG. 9, which is a schematic illustration of a sixth fluorescence-based detection system using waveguides with a sub-wavelength deformation zone, generally referenced 500, constructed and operative in accordance with another embodiment of the disclosed technique. FIG. 9 depicts a top excitation configuration where a sub-wavelength deformation zone is introduced to the waveguide in order to trap the excitation within the waveguide. FIG. 9 shows a unified chip design in which detection system 500 is a substantially a monolithic structure.

A silicon substrate 502 includes a photodetector 504 embedded therein, thus generating a smooth surface on top of which a physical filter 506 is placed. A lower cladding layer 508, which may be made from SiO₂, is flush with a core 510, made from a transparent semiconductor dielectric material, above which is located an upper cladding layer 512, which can also be made from SiO₂. Core 510 is made from a different dielectric constant as compared to lower and upper cladding layers 508 and 512. Core 510 and lower and upper cladding layers 508 and 512 together form a waveguide of the disclosed technique, as described above in previous embodiments of the disclosed technique. In the embodiment in FIG. 9, core 510 has a sub-wavelength deformation zone 526 at one end. Upper cladding layer 512 includes a container 514, which may be filled with a solution (not shown) and a biomaterial 516. Container 514 may be covered by a cover 518. A light source 520, which may be an in-package collimated LED or a laser diode, emits a light beam 524 through a light source filter 522. Light beam 524, which may be positioned at an angle to core 510, is directed to sub-wavelength deformation zone 526 which has a different index of refraction as compared to core 510. Sub-wavelength deformation zone 526 enables light beam 524 to remain trapped in core 510 and thus propagate along core 510 without having to collimate light source 520 with core 510. In general, for example in the construction of detection system 350 (FIG. 6), the diameter of the entrance of a core of a waveguide may be on the order of hundreds of nanometers (such as 200 nanometers), thus making it more complex to collimate light from a light source into the core of the waveguide since as mentioned, the core of the waveguide is very narrow. By using a sub-wavelength deformation zone according to the disclosed technique, light can be introduced into the core of the waveguide without having to collimate it to the very narrow entrance of the core, thus simplifying the construction of the detection system of the disclosed technique. Thus as shown, by using a sub-wavelength deformation zone according to the disclosed technique, light beams can be entered into the core of a waveguide from either above (shown above in FIG. 7) or diagonally (as shown in FIG. 9) without the need for collimating the light beams. According to the disclosed technique, light beam 524 passes through upper cladding layer 512 and is caught by sub-wavelength deformation zone 526 which then propagates light beam 524 as light beam 528 through core 510. After being coupled into the waveguide by sub-wavelength deformation zone 526, light beam 524 continues to propagate as light beam 528, which leaks and exits along core 510 in a thin portion 513 of upper cladding layer 512 as light beams 530 into container 514. At least some of light beams 530 impinge upon biomaterial 516 which reacts with the light beams and emits in response at least one radiation beam 532 which is detected by photodetector 504.

Reference is now made to FIG. 10, which is a schematic illustration of a seventh fluorescence-based detection system using waveguides with an embedded light source, generally referenced 550, constructed and operative in accordance with a further embodiment of the disclosed technique. FIG. 10 depicts an embedded light source construction in which an LED is placed within a silicon substrate (or within a well of another semiconducting material embedded in the silicon substrate) and uses a reflecting surface and/or a sub-wavelength deformation zone to trap emitted light beams in a waveguide. The embodiment of FIG. 10 represents a single chip embodiment of the disclosed technique wherein all components of the detection system, including the light source and the photodetector, are placed within a monolithic structure and can be manufactured as a single chip. A substrate 552, which may be made of silicon, Includes an encapsulated photodetector 554 as well as an encapsulated light source 556, which may be embodied as an LED and may be constructed within a well (not shown) of another semiconducting material embedded in the silicon substrate. A physical filter 560 is placed adjacent to photodetector 554 and a light source filter 562 is placed adjacent to light source 556. A lower cladding layer 558 of a waveguide (not labeled) includes corresponding wells for physical filter 560 and light source filter 562. An upper cladding layer 574 of the waveguide includes a container 576 in which a biomaterial 578 is placed together with a solution (not shown). A core 566 is located between lower and upper cladding layers 558 and 574. Container 576 is covered by a cover 580. Core 566 can be made from a transparent semiconductor dielectric material having a different index of refraction than lower and upper cladding layers 558 and 574. As shown, upper cladding layer 574 has a thin portion (not labeled) under container 576 to enable light propagating down core 566 to exit and escape into container 576. A reflector 568 is embedded in core 566 to deflect a light beam 564 emitted from light source 556 towards core 566. Light source 556 emits light beam 564 through light source filter 562. Reflector 568 deflects light beam 564 such that it propagates along core 566 as a light beam 570. Light beam 570 leaks and exits core 566 as light beams 572 in the thin portion (not labeled) of upper cladding layer 574 which enter container 576 and interact with biomaterial 578. At least some of light beams 572 excite biomaterial 578, which in turn emits radiation beam 582 towards photodetector 554. Unlike previous embodiments of the disclosed technique, the embodiment shown in FIG. 10 is completely encapsulated and monolithic in structure with both the light source and the photodetector being embedded within the chip.

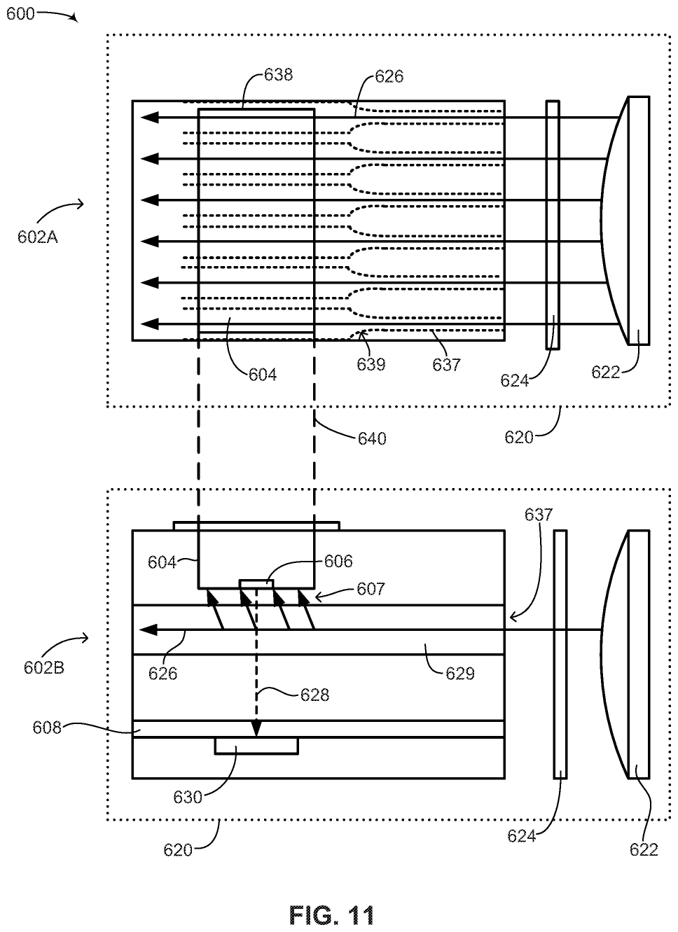

Reference is now made to FIG. 11, which is a schematic illustration of a magnified view of a waveguide as used in a fluorescence-based detection system, generally referenced 600, constructed and operative in accordance with another embodiment of the disclosed technique. FIG. 11 depicts a close-up look at the waveguide section from a top view 602A as well as a side view 602B to clarify the 3D structure of the disclosed technique. Dashed lines 620 encapsulate each view of the detection system. The waveguide structure shown in FIG. 11 can be any one of the waveguides as shown above in FIGS. 6, 7, 9 and/or 10. A light source 622 is an in-package collimated LED or laser diode, which may be a blue LED for example. A light source filter 624 is placed adjacent to light source 622 in order to filter out wavelengths that may be detected as light emitted from the biomaterial. As shown, a light beam passing through light source filter 624 enters a waveguide 637 as a light beam 626 (both in side view 602B and top view 602A). As shown, waveguide 637 may include a tapering section 639 for changing the mode of light beam 626 as it approaches container 604. Light beam 626 exits the core of waveguide 637 in the area under a container 604 wherein a biomaterial 606 is located and excites the biomaterial. The excited biomaterial emits a radiation beam 628, which is then detected by a photodetector 630. A plurality of dashed lines 640 represents the boundaries of container 604 (i.e., the boundaries of a reaction chamber), which may be designed to be a square having for example dimensions of 50 μm (microns) by 50 μm. A side 638 of container 604 is shown in top view 602A. The depth of container 604 may for example be 2 μm. The thickness of a core 629 of waveguide 637 may be for example 150 nm (nanometers). The height of a thin portion 607 separating container 604 from core 629 may be for example 50 nm. FIG. 11 is not drawn to scale in order to show the various parts of the waveguide structure, however as described above, container 604 may be larger and deeper than the waveguide as shown and may accommodate several waveguides for providing excitation. The thickness of a physical filter 608 adjacent to photodetector 630 (e.g., a photodiode) is typically be less than 20 μm. The width of the upper and lower cladding layers surrounding each side of core 629 may be for example between 20-200 μm. The wavelength of the emitted light from light source 622 may be for example 400 nm and the wavelength of the radiation emitted from biomaterial 606 may be for example 500 nm.

It is noted that the waveguide structure, including the core and the upper and lower cladding layers, as described in the embodiments of the disclosed technique, has been described as being made from silicon dioxide (SiO₂) as an example. According to the disclosed technique, the upper and lower cladding layers as well as the core of the waveguide structure of the disclosed technique can be made from any transparent material that is compatible with the material from which the substrate of the detection system is made from. Typically, the substrate is made from silicon, thus the waveguide structure can be made from any material which is compatible with silicon. This can include, for example, the following materials: TiO₂, Ta₂O₅, Nb₂O₅, Si₃N₄, Al₂O₃ and SiNₓ. It is noted as well that the core of the waveguide structure of the disclosed technique has to be transparent whereas the upper and lower cladding layers should also be transparent however they can be embodied as layers which are only semi-transparent. In the case that the upper and lower cladding layers are not completely transparent, some signal loss of the light beams which leak into the container may occur as well as some signal loss from the light beams which are emitted from the biomaterial.

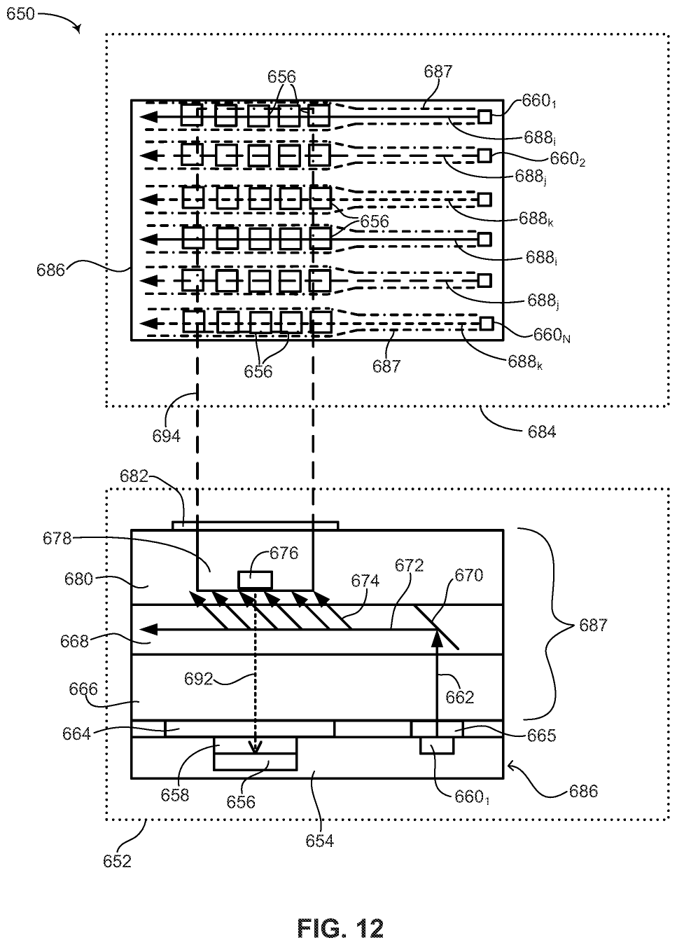

Reference is now made to FIG. 12, which is another a schematic illustration of the seventh fluorescence-based detection system using waveguides with an embedded light source for multi-wavelength excitation, generally referenced 650, constructed and operative in accordance with a further embodiment of the disclosed technique. FIG. 12 shows how the detection system of FIG. 10 can be used wherein the embedded LED can be extended to enable multi-wavelength excitation. The embedded LED can be implemented either by using multiple LEDs having different wavelengths or by using a single LED which can emit different wavelengths. As described below, the embedded LED or LEDs may share the same optical waveguide layer as a broadband optical waveguide material may be used. Alternatively, a plurality of waveguides can be used, one per emitted wavelength. The different wavelengths can also share the same filter layer placed in front of the photodetectors, whose main purpose is to reject wavelengths of the excitation radiation meant for the photodetector but do allow to pass the wavelengths of the fluorescence emissions (i.e., the radiated light from the biomaterial). An additional dye filter may be added to individual photodetectors to respectively pass excited radiation light beams of a respective wavelength to a respective photodetector.

FIG. 12 depicts a side view 652 (bottom of FIG. 12) and a top view 684 (top of FIG. 12) of multi-wavelength excitation detection system 650 using a plurality of light sources 660₁-660_{N}. Each one of the light sources may have a respective light source filter 665 (shown only in side view 652) for generating a light beam 662 of a particular wavelength. Similar to the constructions mentioned above, FIG. 12 shows a substrate 654 in which a plurality of photodetectors 656 are placed and which also includes a physical filter 664. As shown, a single large physical filter may be used for all the photodetectors or a plurality of physical filters can be used. Top view 684 shows that substrate 654 includes a matrix of photodetectors 656 arranged in rows and in line with a plurality of waveguides 687. Detection system 650 also includes a plurality of dye filters 658, positioned before plurality of photodetectors 656. As shown, plurality of dye filters 658 are placed between physical filter 664 and plurality of photodetectors 656, however plurality of dye filters 658 can also be placed above physical filter 664. As mentioned above, plurality of light sources 660₁-660_{N} may be a single LED or a plurality of LEDs. In general, plurality of light sources 660₁-660_{N} generate light beams of different wavelengths, usually within the visible spectrum and thus the different generated wavelengths are expressed as light beams of different colors.

As shown, plurality of waveguides 687 includes a lower cladding layer 666, which is placed adjacent to physical filter 664, a core 668 via which light beams travels and an upper cladding layer 680. Core 668 is made from a transparent semiconductor dielectric material having a different dielectric coefficient than lower and upper cladding layers 666 and 680 such that light beams in core 668 propagate along core 668 via TIR. As shown, upper cladding layer 680 includes a plurality of containers 678 in which a plurality of biomaterial samples 676 is placed, optionally with a solution (not shown). Plurality of containers 678 may be covered by a cover 682. Similar to other constructions described above, upper cladding layer 680 has respective thin portions (not labeled) under plurality of containers 678 which allow light beams propagating in core 668 to escape and leak out into plurality of containers 678. The complete chip 686 is shown in top view 684 and side view 652.

When multiple light sources are used, each one sends a light beam, optionally at a different wavelength. For example, FIG. 12 presents an example in which a cyclic pattern (i, j, k) of three different wavelengths is implemented, thus creating constant sets of adjacent beams with different wavelengths: 688ᵢ, 688ⱼ, 688ₖ, 688ᵢ, 688ⱼ, 688ₖ. Light source 660₁ transmits a light beam 668ᵢ at a first wavelength, light source 660₂ transmits a light beam 668ⱼ at a second wavelength and light source 660_{N} transmits a light beam 668ₖ at a third wavelength. As shown in top view 684, plurality of waveguides 687 each includes a tapering section (not labeled) which can expand the mode of the light propagated therein. In side view 652, which only shows a single light source 660₁, the light source sends a light beam 662, which is deflected by a reflector 670 and travels through core 668 as a light beam 672 (equivalent to light beams 688ᵢ-688ₖ as shown in top view 684). Light beam 672 (and equivalently all the light beams shown in top view 684) leaks and exits core 668 at the respective thin portion under each one of plurality of containers 678 as light beams 674 that impinge on plurality of biomaterial samples 676 located in plurality of containers 678. Dashed lines 694 in top view 684 show the equivalence of the position of plurality of containers 678 in side view 652. In response to being excited, plurality of biomaterial samples 676 each emit a respective radiation beam 692, which is then filtered by physical filter 664 and subsequently by plurality of dye filters 658 and then detected by photodetector 656. Plurality of dye filters 658 can be embodied as any kind of chemical filter wherein the filtering action involves an interaction on the molecular level. Thus plurality of dye filters 658 can be embodied as a pigment filter, for example. Plurality of dye filters 658 selectively filter out different wavelengths depending on the wavelengths of the excited radiation from biomaterial 676. Thus the dye filters located above the photodetectors in line with light source 660₁ filter out radiation emissions outside the range of expected fluorescent emissions from the biomaterial when excited by a light beam having wavelength 688ᵢ. Likewise, the dye filters located above the photodetectors in line with light source 660₂ filter out radiation emissions outside the range of expected fluorescent emissions from the biomaterial when excited by a light beam having wavelength 688ⱼ. And so forth regarding the dye filters located above the photodetectors in line with light source 660_{N}, which filter out radiation emissions outside the range of expected fluorescent emissions from the biomaterial when excited by a light beam having wavelength 688ₖ. Using the construction of detection system 650, plurality of biomaterial samples 676 can be illuminated by a plurality of different wavelengths and thus the presence or absence of a plurality of fluorescent biomarkers in the biomaterial samples can be determined simultaneously.

In an alternative embodiment to FIG. 12, plurality of light sources 660₁-660_{N} can be embodied as a single light source that transmits light beams at different wavelengths and thus the construction could utilize only a single waveguide. In such an embodiment, a plurality of physical filters and dye filters may be required for each photodetector to separate out the different excitation radiation beams from the plurality of biomaterial samples, similar to how a CCD camera has a plurality of color filters for each pixel in its imaging array.

Reference is now made to FIG. 13, which is a schematic illustration of an eighth fluorescence-based detection system, generally referenced 700, constructed and operative in accordance with another embodiment of the disclosed technique. FIG. 13 discloses another construction of the disclosed technique in which an additional transparent layer is positioned between the physical filter and the photodetector. This additional layer can be SiO₂ or any other transparent material compatible with the material the base substrate is made from, which is typically silicon. This additional layer can be constructed having sub-wavelength deformations made of a transparent material having a different dielectric constant as compared to the layers above it, thus designed to function as an optical lens. FIG. 13 shows a side view of the detection system. It is noted that from a top view, any sub-wavelength deformations might appear as concentric circles. The sub-wavelength deformations serve to provide passive optical gain and enable the collection of more photons from the excited radiation beams into a smaller-sized photodetector thus improving the SNR of the detected radiation.

As shown in FIG. 13, a substrate 702 may be made of silicon. Substrate 702 includes a photodetector 704 placed therein. As in previous embodiments, photodetector 704 may be embodied as a photodiode. Adjacent to substrate 702, an additional transparent layer 706 is deposited including a sub-wavelength deformation zone 708 which effectively varies the dielectric coefficient of additional transparent layer 706 in a spatially dependent manner, thereby providing the functionality of an optical lens. This is schematically shown as plurality of deformation zones 709. Adjacent to additional transparent layer 706, a physical filter 710 is placed. Above physical filter 710 is a waveguide including a lower cladding layer 712, a core 714 and an upper cladding layer 728. Core 714 is made from a transparent semiconductor dielectric material having a different dielectric constant as compared to upper and lower cladding layers 728 and 712. Upper cladding layer 728 includes a container 726 in which a biomaterial 724 is placed, optionally with a solution (not shown). Container 726 may be covered using a cover 730. As shown, upper cladding layer 728 has a thin portion (not labeled) under container 726 for enabling light beams in the core to leak out and escape into container 726. A light source 716 sends a beam of light 720 through a light source filter 718 into core 714. It is noted that light source 716 can also be built into substrate 702 thus giving detection system 700 a single chip design. Light beams 722 split from light beam 720 and leak and exit into container 726 under the thin portion. At least a portion of light beams 722 impinge on biomaterial 724, which may emit in response a plurality of radiation beams 734. In FIG. 13, plurality of radiation beams 734 is shown as two radiation beams using dashed lines. Radiation beams 734 are filtered by physical filter 710. Upon reaching sub-wavelength deformation zone 708, radiation beams 734 are diverted towards photodetector 704 and focused onto the photodetector, similar to an optical lens. This is instead of traveling in a straight line all the way (which is depicted as radiation beam 732 and shown only as a reference). Thus in this embodiment, a smaller photodetector may be used to collect all the fluorescent radiation emitted from biomaterial 724.

Optical materials suitable for use in the optical waveguide of the disclosed technique include at least: SiO₂, TiO₂, Ta₂O₅, Nb₂O₅, Si₃N₄, Al₂O₃ and compounds having the general chemical formula SiNₓ. It is disclosed that the integration with silicon enables the inclusion of heat generating components as well as temperature sensors (placed directly under the container) in order to tightly control the temperature profile of the biological/chemical/biochemical reaction(s) taking place in the container.

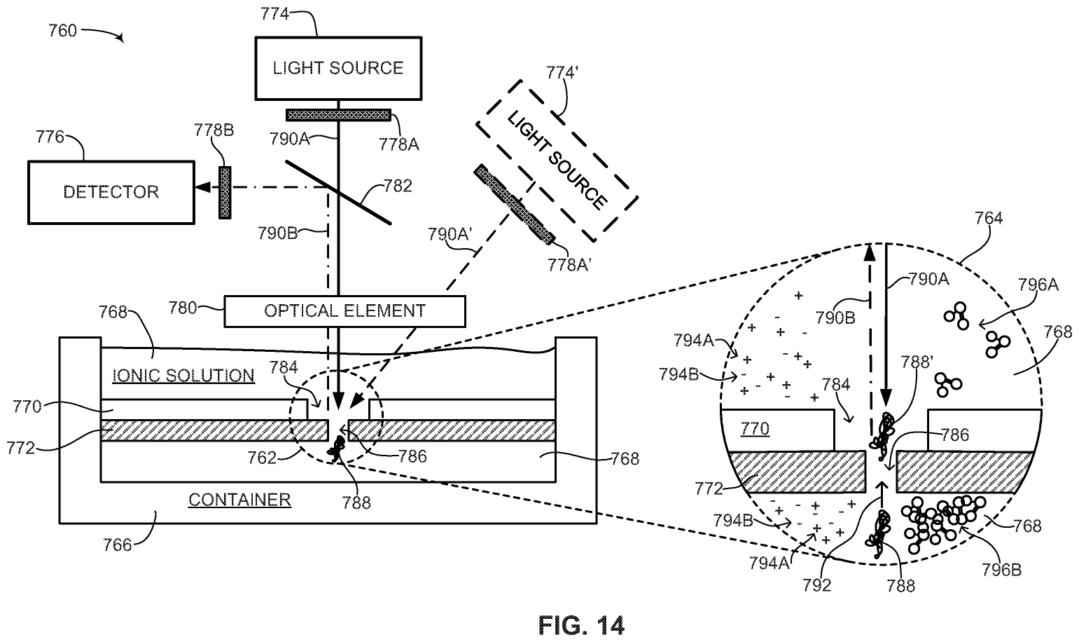

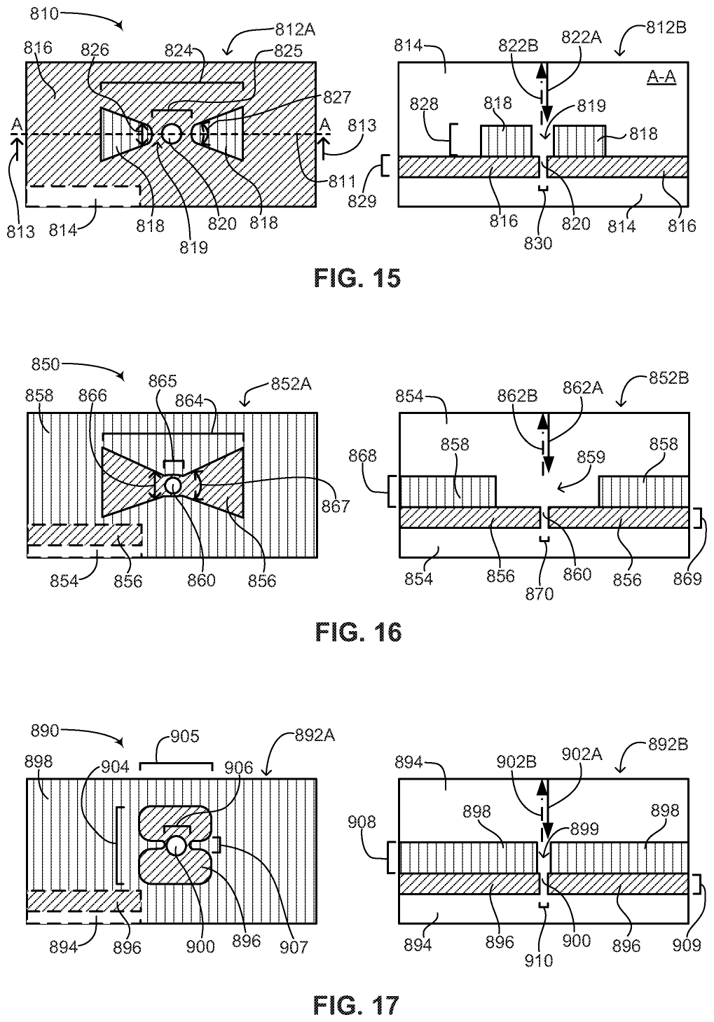

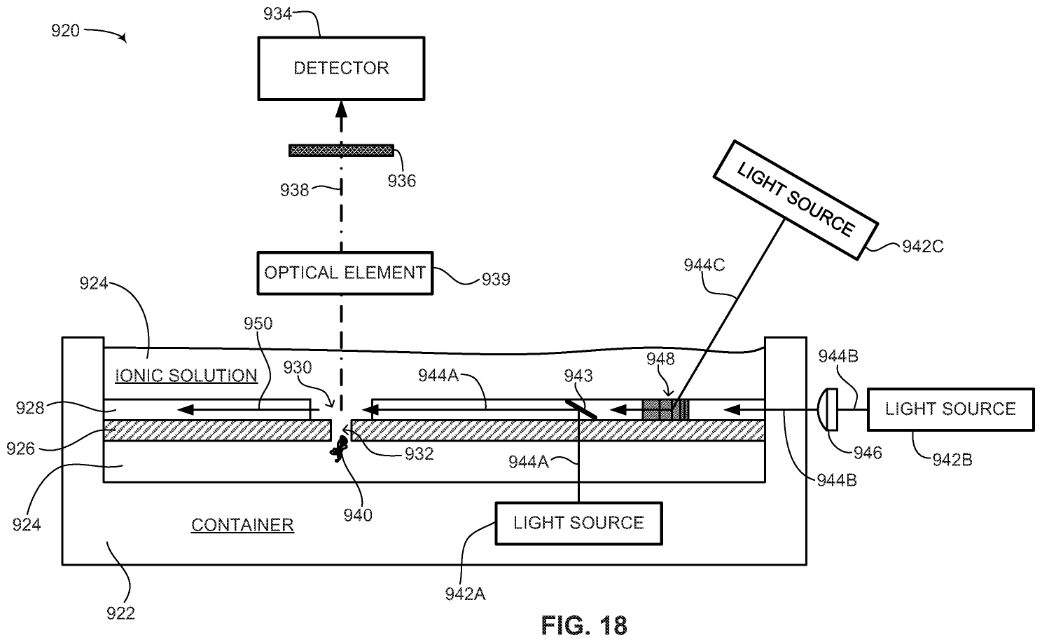

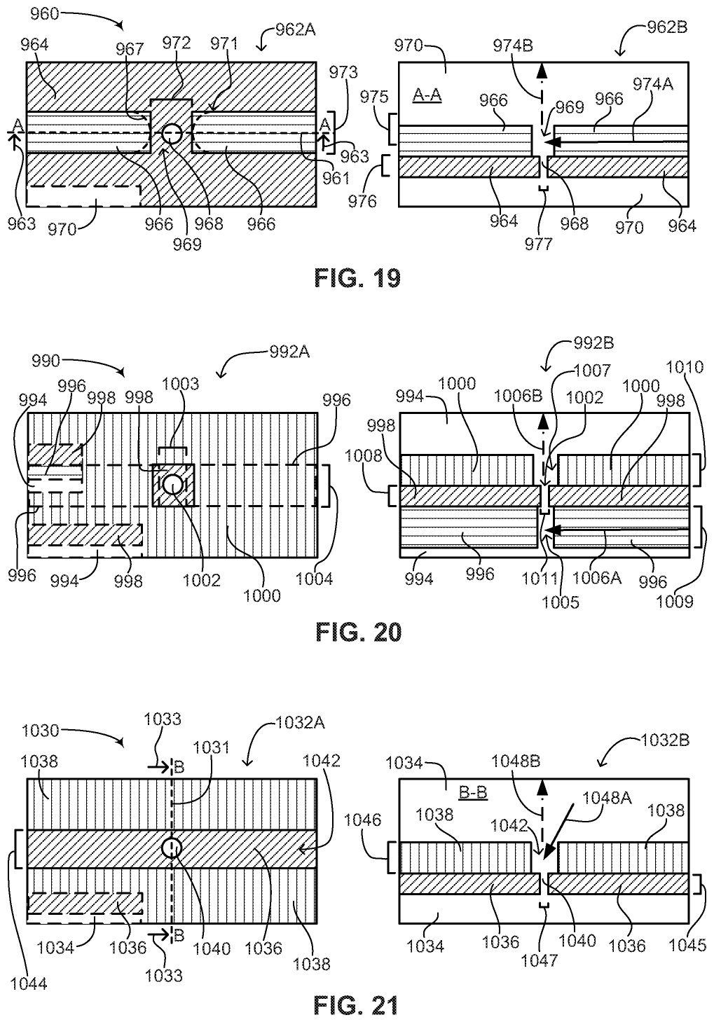

As mentioned above, the disclosed technique also relates to fluorescence-based detection systems using nanopores and/or nanopores with waveguides. According to the disclosed technique, two general configurations of a fluorescence-based detection are presented, one using nanopores, as described below in FIG. 14, and one using nanopores and waveguides, as described below in FIG. 18. Each one of FIGS. 14 and 18 gives a detailed description of one of the configurations, wherein FIGS. 15-17 and 22 describe different arrangements of the EM concentration layer (for example a metal film layer) of the configuration of FIG. 14 and wherein FIGS. 19-21 describe different arrangements of the waveguide layer of the configuration of FIG. 18. Both configurations as presented below in FIGS. 14 and 18 can be used for biosensing applications as described above in other embodiments of the disclosed technique. It is noted that the dimensions shown in FIGS. 14-22 below are relative and schematic and should not be taken to scale.

Reference is now made to FIG. 14, which is a schematic illustration of a first configuration of a fluorescence-based detection system using nanopores, generally referenced 760, constructed and operative in accordance with a further embodiment of the disclosed technique. First configuration 760 includes a reaction chamber 766 (also referred to as simply a container 766), a solid state membrane 772 (also referred to as a nanopore membrane 772), an EM concentration layer 770, an ionic solution 768, a light source 774, a light source filter 778A, a detector 776, a detector filter 778B, a dichroic mirror 782 and an optical element 780. Container 776 contains ionic solution 768, solid state membrane 772 and metal film 770. Container 776 may be formed on or as part of a substrate (not shown). As shown, solid state membrane 772 includes a very small pore 786, which can be referred to as nanopore 786 (and hence solid state membrane 772 is also referred to as nanopore membrane 772). Even though one nanopore is shown FIG. 14 for the purposes of explaining the invention, it is clear to the worker skilled in the art that nanopore membrane 772 may include a plurality of nanopores. EM concentration layer 770 can be embodied as a metal film and is thus also referred to in the description as metal film 770. As shown, metal film 770 has an opening 784, which as shown, is positioned over nanopore 786 and is slightly larger than nanopore 786. A close-up of nanopore 786 and opening 784 as surrounded by a dotted circle 762 is shown magnified by a dotted circle 764. Light source 774 is positioned such that an emitted light beam 790A is directed towards opening 784 and nanopore 786. Light source filter 778A, which is an optional component, is positioned adjacent to light source 774 for enabling at least one specific band (i.e., a range of wavelengths) of light to pass there through towards container 766 and opening 784. Optical element 780 can be embodied as any optical element capable of focusing light beams emitted from light source 774 towards opening 784, thus optical element 780 can be a lens, an objective lens of a microscope, an optical coupler and the like. As shown, light source 774 does not need to be placed directly above opening 784 and can be positioned at an angled position, shown in dotted lines as a light source 774′, a light source filter 778A′ and an emitted light beam 790A′. The position of light source 774′, which is approximately 45 degrees from the position of light source 774, is merely brought as an example, and light source 774′ could be positioned at other angles relative to the position of light source 774 provided emitted light beam 790A′ can travel directly to opening 784. In the case of optical element 780 being embodied as a lens, the positioning of light source 774′ may be achieved by moving and adjusting the focal plane of optical element 780. It is noted that container 766 may be made from a transparent material such that light source 774′ can be positioned under container 766, thereby emitting light beam 790A′ directly onto nanopore 786. Even though such an embodiment is not explicitly shown in FIG. 14, positioning light source 774′ under container 766 is part of the disclosed technique. Container 776 can be made from transparent materials such as silicon elastomers which are singular component and either UV curable (for example polydimethylsiloxane (PDMS)) or oxygen curable, plastics (such as polytetrafluoroethylene (PTFE), polyvinylidene (PVDF), polystyrene (PS) or poly(methyl methacrylate) (PMMA)) and/or epoxy resins. Light source 774 (and 774′) can be embodied as a laser diode or an LED, for example. It is noted as well that light source 774 is shown as a single light source emitting a single light beam in FIG. 14 however light source 774 can be embodied as a plurality of laser diodes or LEDs, each emitting light beams at a different wavelength.

Emitted light beam 790A passes through optical element 780 which collimates the light beam towards opening 784 and nanopore 786 for exciting a polymer 788 which produces fluorescence as an emitted radiation beam 790B. As shown, polymer 788 is placed in ionic solution 768 which acts as a neutral medium (i.e., ionic solution 768 does not interact chemically with polymer 788). Ionic solution 768 thus enables polymer 788 to float around and eventually pass through nanopore 786 (as described below). Ionic solution 768 is selected such that it will not emit fluorescence when illuminated by light source 774, thus the only fluorescence emitted from container 766 should be the fluorescence from polymer 788. Dichroic mirror 782, which is also an optional element, is positioned in the path of both emitted light beam 790A and emitted radiation beam 790B for enabling the wavelengths of emitted light beam 790A to pass there through and for reflecting the wavelengths of emitted radiation beam 790B towards detector 776. Detector filter 778B prevents stray light beams from light source 774 (and any other light source in the area) as well as radiation light beams outside the expected wavelength range of radiation light beams emitted from polymer 788 from reaching detector 776. Detector filter 778B may also be an optional component. As can be seen, depending on the positioning of light source 774 and detector 776, dichroic mirror 782 may not be needed (and hence is an optional component), for example if the light source is positioned beneath container 766 and detector 776 is positioned above container 766. Optical element 780 may also collimate emitted radiation beam 790B such that it is reflected towards detector 776. Detector 776 may be coupled with an analyzer (not shown) and/or a processor (not shown) for analyzing detected emitted radiation beam 790B.

Regarding dimensions, nanopore membrane 772 may have a thickness ranging from 20-100 nanometers (herein abbreviated nm), with nanopore 786 having a diameter between 4-40 nm. Metal film 770 may have a thickness of 20-300 nm, with opening 784 also having a diameter of between 4-40 nm. Whereas nanopore 786 may be chemically drilled into nanopore membrane 772, thus giving nanopore 786 a circular or cylindrical shape with dimensions properly described using a term such as diameter, as described below in FIGS. 15-17 and 22, opening 784 can take on various shapes and may not be circular or cylindrical. Metal film 770 can be made from conductor metals such as gold (Au), silver (Ag), aluminum (Al) or copper (Cu) and nanopore membrane 772 can be made from materials such as low stress silicon nitride having the chemical formula SiN_{X} where ‘X’ is the ratio of nitride to silicon and is chosen to achieve a low stress condition for nanopore membrane 772. The value of ‘X’ in SiN_{X} may be process dependent, thus different values of ‘X’ may be chosen in order to achieve the desired low stress condition of the silicon nitride depending on the process used to fabricate nanopore membrane 772. Nanopore membrane 772 can also be made from silicon dioxide (SiO₂). In general, EM concentration layer 770 is opaque to emitted light beams from light source 774 (partly due to the thickness of EM concentration layer 770), however nanopore membrane 772 may be transparent or translucent to emitted light beams from light source 774. Nanopore membrane 772 may be made from an inorganic material which is also dielectric, such as SiNₓ and SiO₂, as mentioned above.

Shown in FIG. 14 is a single container with a nanopore membrane exhibiting a single nanopore and an EM concentration layer (for example a metal film) exhibiting a single opening. This is merely for illustrative purposes. Container 766 may be part of an array of containers (not shown), each container including a nanopore membrane with a respective nanopore and a metal film with a respective opening. In another embodiment, nanopore membrane 772 may include a plurality of nanopores and metal film 770 may include a corresponding plurality of openings for a single container. It is noted as well that even though metal film 770 is shown as completely covering nanopore membrane 772 except for the area near nanopore 786, metal film 770 does not need to completely cover nanopore membrane 772 and it is sufficient that it covers a significant area around nanopore 786. As described below, EM concentration layer 770 is used to concentrate the light beams emitted by light source 774 to nanopore 786. Thus it may be sufficient that metal film 770 covers an area, for example, that is five times the wavelength of the light beams illuminating nanopore 786, however for distances from the nanopore beyond that, no metal film must be deposited on nanopore membrane 772. As a numerical example, if nanopores are spaced 10000 nm apart and the wavelength of light used to illuminate each nanopore is about 500 nm, then for a radius of 2500 nm around each nanopore the metal film may be deposited, but for distances beyond the 2500 nm radius, no metal film will be deposited on the nanopore membrane. In the disclosed technique, at least one polymer of interest for analysis, as described below, may be placed in a given quantity within ionic solution 768. In the case of an array of containers, different polymers may be placed in the respective ionic solution of each container for analysis. In another embodiment of the disclosed technique, a plurality of different polymers may be placed in a given container, which may include a single nanopore or a plurality of nanopores, wherein the device of the disclosed technique can be used to identify the different polymers as they pass through the nanopore.

One of the uses of the disclosed technique using nanopores is to fingerprint polymers of interest which give off fluorescence. In this use, only a portion of the compounds and molecules making up the polymer need to be identified to identify (to a desired level or degree of certainty) the polymer crossing through the nanopore. Another use of the disclosed technique using nanopores is to further decipher and determine the actual constituents of a polymer of interest (including their order) which gives off fluorescence. Determining the constituents of a polymer includes the compounds and molecules making up the polymer as well as their position and order within the polymer. The polymer may be any macromolecule which is organic or inorganic, including examples such as proteins, DNA, RNA, lipids and polypeptides. Regardless of the nature of polymer 788, for the disclosed technique, the polymer must either give off fluorescence naturally when excited by a light beam (i.e., it is naturally fluorescent) or must be treated chemically to have fluorescent markers added to the polymer. Fluorescent markers can also be added to the polymer via intercalation, chemical bonding and other known methods for adding fluorescent markers to polymers and compounds of interest (such as done, for example, for marking DNA, RNA and protein molecules). As described below, ionic solution 768 is concocted in various ways (such as through the use of an applied electric field) to cause polymer 788 to move through nanopore 786, either from the lower portion of ionic solution 768 (i.e., below nanopore membrane 772) to the upper portion of ionic solution 768 (i.e., through opening 784 towards the volume of ionic solution 768 above metal film 770), or from the upper portion of ionic solution 768 to the lower portion of ionic solution 768. Polymer 788 may be a protein, which may be folded onto itself, or may be other kinds of compounds, such as DNA or RNA, which are naturally unraveled and not folded onto themselves. In either case, the diameter of nanopore 786 is large enough that polymer 788, which may be unfolded, or which may be a compound having different molecules folded up onto themselves, is able to pass through nanopore 786 without having to unravel the polymer. In general, the diameter of nanopore 786 is chosen to ensure that polymer 788 (especially in the case of an unfolded polymer) threads through nanopore 786 as slowly as possible (but does not block or get stuck in nanopore 786) and in a direction parallel with the longitudinal axis of nanopore 786 (i.e., the axis of nanopore 786 going in a direction through nanopore 786, similar to the direction of travel of the polymer through the nanopore). Polymer 788 may move through nanopore 786 as a folded polymer, as an unfolded polymer or as an already unraveled polymer. Whereas information about polymer 788 (such as at least a portion of its constituents) can be derived from fluorescence it emits even as a folded polymer (for example in the case of a protein) and is applicable to the disclosed technique, more information about polymer 788 can be derived if polymer 788 is either unraveled or is not a folded protein (for example, information can be derived of not just at least a portion of its constituents but also of the order of its constituents). As polymer 788 moves through nanopore 786, light source 774 emits light beam 790A which interacts with the specific portion of polymer 788 travelling through nanopore 786. Fluorescence from that specific portion of polymer 788, in the form of radiation beam 790B, is then detected by detector 776. The specific wavelength(s) detected can be used by an analyzer (not shown) and/or a processor (also not shown), coupled with detector 776, to determine the nature of at least a portion of the constituent molecule(s) of the specific portion of polymer 788 which emitted radiation beam 790B. As further portions of polymer 788 pass through nanopore 786 and are illuminated by light source 774, each portion in turn will emit another one of radiation beam 790B to be detected by detector 776. In this manner, polymer 788 can be “scanned” or read and at least a portion of the different constituent molecule(s) of polymer 788, including their order in polymer 788 in some cases, can be determined. As mentioned above, in the case of fingerprinting polymers according to the disclosed technique, not every molecule or monomer in polymer 788 needs to be detected, and sub-sampling of polymer 788 by the identification of at least one specific constituent molecule may be sufficient to determine (to a desired degree or level of certainty) the nature of polymer 788. As an example, polymer 788 may be a protein made up of various amino acids (i.e., constituent molecules). In such an example, as polymer 788 passes through nanopore 786, at least some of the amino acids constituting polymer 788 can be “scanned” or read based on the fluorescence detected by at least some of the portions of polymer 788 as it passes through nanopore 786. In the case of fingerprinting, at little as about 10% of the constituent monomers in a protein may need to be detected in order to identify polymer 788. In the case of an unknown polymer, such as an unknown protein, all the constituent monomers of polymer 788 may need to be detected and identified. In this case, according to the disclosed technique, the various amino acids, and their order, in the polymer can be determined. Whereas the prior art also attempts to illuminate polymers for the purposes of fingerprinting and detection and analysis, fingerprinting and identification of polymers in the disclosed technique enables a greater portion of the light beams from light source 774 to be focused specifically on nanopore 786, thus enabling higher SNR of the emitted radiation beams from the illuminated polymer in detector 776 and increasing the ability of the device of the disclosed technique to discriminate between the different constituents of the polymer as well as their order within the polymer.

The accuracy at which polymer 788 can be read and in given uses, its constituent molecules determined, depends largely on the amount of fluorescence given off by the various portions of polymer 788 as they each pass through nanopore 786. The amount of fluorescence emitted by polymer 788 is itself influenced by how much photonic excitation polymer 788 absorbs from emitted light beam 790A. Said otherwise, the amount of fluorescence emitted by polymer 788 is itself influence by the strength of the electromagnetic (herein abbreviated EM) field generated by the light beams emitted from light source 774 which are concentrated into opening 784 and nanopore 786. The amount of fluorescence emitted by polymer 788 is also influenced by the ability to concentrate illumination from light source 774 to the specific spatial location of nanopore 786 and not to other sections of container 766 which may generate undesired emitted radiation signals (i.e., noise) that can be detected by detector 776. According to the disclosed technique, the structure of first configuration 760 (as described in greater detail below in FIGS. 15-17 and 22, in particular regarding EM concentration layer 770) is designed to enable an increased concentration of photonic excitation of the fluorescent molecules of polymer 788 in the spatially constrained volume of nanopore 786. The design of first configuration 760 is such that the excitation field (i.e., the EM field) coming from emitted light beam 790A is spatially concentrated towards opening 784 while nanopore 786 spatially constrains and forces polymer 788 to traverse a precise spatial location in which photonic excitation is concentrated. This setup thus enables increased fluorescence from polymer 788 and thus an increased discrimination between spatially adjacent fluorescent molecules constituting polymer 788 which traverse through nanopore 786. The design of first configuration 760 specifically includes an EM concentration layer (which may be embodied as a metal film), having different designs as described below, which is used to generate a strong EM field near nanopore 786. In this configuration, the increased EM field would not be possible without EM concentration layer 770.

Referring now to dotted circle 764, nanopore membrane 772 and metal film 770 can be seen clearly, as can polymer 788. Dotted circle 764 shows at least two different methods of how polymer 788 can be caused to move through nanopore 786 towards opening 784, for example in the direction of an arrow 792, from a first position (polymer 788) to a second position (a polymer 788′). In a first method, as described above, the solution in which polymer 788 is placed in is an ionic solution, i.e., a solution having charge carriers. Shown in dotted circle 764 are positive charges 794A and negative charges 794B in ionic solution 768. By applying an electric current (not shown) to ionic solution 768 (using a cathode and anode (both not shown)), a current flow in ionic solution 768 will be generated, causing polymer 788 to flow through nanopore 786 in the direction of arrow 792 (or vice versa if the cathode and anode are reversed). The electric current can be applied via the insertion of a cathode and an anode in the ionic solution, for example by inserting an anode above metal film 770 and a cathode below metal film 770. In a second method, instead of using an ionic solution and providing an electric current (which requires additional components for first configuration 760), the solution in which polymer 788 is placed can be mixed to have a concentration gradient between the two sides of nanopore membrane 772 and metal film 770. As shown on the right hand side below nanopore membrane 772, the solution has a high concentration of a particular ion 796B (which is not polymer 788), whereas above metal film 770, the solution has a low concentration of the same particular ion 796A. Due to the law of diffusion, ions 796B will move through nanopore 786 and opening 784 towards ions 796A, thus creating an internal electric field and causing a flow of the solution in the direction of arrow 792. This flow will also cause polymer 788 to move in the direction of arrow 792. In this second method, movement of polymer 788 through nanopore 786 can be effected without the use of an applied external electrical current. Other methods for causing a flow of the solution through nanopore 786 are possible, for example by fabricating nanopore membrane 772 as an active membrane which threads polymers such as DNA and RNA there through.

In first configuration 760, light source 774 and detector 776 are designed to function within the general bounds of the visible light spectrum. Thus light source 774 can emit light beams in the range of approximately 400 nm to 850 nm in wavelength, give or take about 100 nm on either limit. And likewise, detector 776 can detect emitted radiation beams in the same general range. Furthermore, light source 774 may polarize emitted light beam 790A, wherein the polarization may be linear or circular. The polarization of emitted light beam 790A can also be perpendicular to the surface of metal film 770 or at another angle in relation to the surface of metal film 770 depending on the particular design dimensions of first configuration 760. As mentioned above, light source 774 and detector 776 may be positioned above container 766 (as illustrated) or below container 766 or in a combination of being above and below (for example with the light source being below container 766 and the detector being above 766 or vice-versa).

As shown, metal film 770 is located directly above nanopore membrane 772. In general, the structure of container 766 and its elements in first configuration 760 can be assembled using known methods in the fabrication of nano-sized structures, such as electrodeposition and chemical etching, deposition, patterning and lift-off and the like. Thus metal film 770 may be deposited on nanopore membrane 772 using known deposition methods, with opening 784 being etched out after deposition.

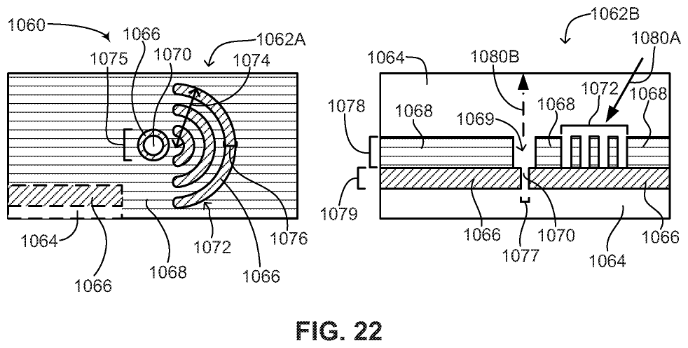

FIGS. 15-17 and 22 below describe in particular specific shapes and structures of EM concentration layer 770, described as different arrangements of EM concentration layer 770. It is noted that the specific shapes and structures describe (which include a bowtie structure (FIG. 15), an hourglass structure (FIG. 16), an H-shape (FIG. 17) and a sub-wavelength grating shape (FIG. 22)) below have been experimented with by the Inventors and have been discovered to concentrate an EM field and provide for enhanced photonic excitation around a nanopore significantly more than a standard and known nanowell placed above a nanopore, such as nanowells having a square opening or a circular opening in a metal film positioned above a nanopore, as is known in the prior art.

Reference is now made to FIG. 15, which is a schematic illustration of a first arrangement of the EM concentration layer of the fluorescence-based detection system using nanopores of FIG. 14, generally referenced 810, constructed and operative in accordance with another embodiment of the disclosed technique. FIG. only shows the ionic solution, nanopore membrane layer and EM concentration layer (for example as a metal film layer) from the fluorescence-based detection system of FIG. 14 however it is clear that the elements of FIG. 14 not shown in FIG. 15 apply to FIG. 15 as well, such as a container, a light source and a detector. FIG. 15 shows a first arrangement of the layers of the detection system from a top view 812A as well as from a side view 812B. Identical reference numbers are used for elements shown in both top view 812A and side view 812B. As shown, a line A-A 811 bisects top view 812A into two sections. Side view 812B is the view of first arrangement 810 along the line A-A in the direction of a plurality of arrows 813. It is noted that the above description applies to the second, third and fourth arrangements of the EM concentration layer, shown below in FIGS. 16, 17 and 22 respectively, regarding only showing the ionic solution, nanopore membrane layer and EM concentration layer (for example as a metal film layer) from the fluorescence-based detection system of FIG. 14 and also regarding showing a top view and a corresponding side view of the particular arrangement. The above description regarding the line in the top view along which the side view is shown also applies to each of FIGS. 16, 17 and 22 respectively even though line A-A 811 and plurality of arrows 813 are not shown or drawn.

With reference to top view 812A, shown is an EM concentration layer 818 (embodied here as a metal layer 818), a nanopore membrane 816, including a nanopore 820 and an ionic solution 814. Ionic solution 814 is shown as a cutaway (with dotted lines) in nanopore membrane 816 as otherwise it would not be seen from top view 812A. It is clear that the cutaway would not be present and viewable in an actual embodiment of first arrangement 810 as viewed from the top. As seen, metal film 818 has a bowtie structure surrounding nanopore 820, composed of two facing triangular shapes forming the bowtie structure. In this arrangement, metal film 818 only covers a small portion of nanopore membrane 816 and is primarily concentrated near nanopore 820. Metal film 818 thus does not form any sort of nanowell around nanopore 820. When light beams (not shown) are directed towards nanopore membrane 816, and specifically nanopore 820, metal film 818, due to its conductive nature as a metal and due to its particular shape, attracts and concentrates the light beams towards nanopore 820, thereby generating a strong EM field and strong photonic excitation near nanopore 820. As explained above, the diffraction limit of the light used in the disclosed technique is on the order of hundreds of nanometers whereas the area where the light is to be focused in on the order of tens of nanometers. Thus a significant amount of the light illuminating the container may be wasted (i.e., is an energy loss) and not used in illuminating the polymer crossing through the nanopore. The light beams which do not cause fluorescence of the polymer can also be a source of noise for the detector (not shown), for example by causing fluorescence to be emitted from other molecules in the ionic solution. According to the disclosed technique, an EM concentration layer having a particular shape is used to attract more light to concentrate around the opening and the nanopore, thereby mitigating the amount of energy loss of the illuminating light beam. The particular shape of the EM concentration layer thus acts as a kind of antenna for attracting and concentrating light beams towards the opening and the nanopore. The bowtie shape of metal film 818 thus enables greater fluorescence to be emitted and detected from a polymer (not shown) passing through nanopore 820 and being illuminated by light beams. As the bowtie structure of metal film 818 is not a simple shape, various quantities and dimensions can be used to describe its shape and structure, which can be tweaked depending on the specific design of first arrangement 810. Since the purpose of metal film 818 is to concentrate the photonic excitation of the light beams towards nanopore 820, the length shown as a length marker 824 can be referred to as lens length 824 and the space between the ends of the triangles forming the bowtie structure shown as a length marker 825 can be referred to as gap length 825. An angle marker 827 can be used to describe the acuteness of each triangle forming the bowtie structure and the vertices of each triangle which immediately face nanopore 820 can be embodied as either vertices of a triangle (not shown) or as a flattened corner tip (as shown), which can be flattened to a width shown as a length marker 826 and referred to as flattened width 826. Using the above quantities, the bowtie structure of metal film 818 can be described as follows. Metal film 818 can have a gap length 825 ranging from 4-40 nm with a lens length 824 ranging from 100-400 nm. The acuteness of angle marker 827 can range from 20-140 degrees and flattened width 826 can range from 0-40 nm (0 nm in the case of a triangle tip or vertex). The volume within gap length 825 substantially forms an opening 819 in metal film 818 which leads to nanopore 820, similar to opening 784 (FIG. 14) and thus representing an embodiment of such an opening. It is noted that the bowtie structure of metal film 818 as shown specifically includes two opposing triangles, however adding more triangles to the bowtie structure (for example a third triangle, a fourth triangle or even more) may be possible as well according to the disclosed technique.

With reference to side view 812B, ionic solution 814, nanopore membrane 816 and metal film 818 can be seen along with their relative thicknesses and positions. As shown, nanopore 820 has a diameter 830 of between 4-40 nm. Nanopore membrane 816 has a thickness 829 which can range from 20-100 nm whereas metal film 818 has a thickness 828 which can range from 20-300 nm. An emitted light beam 822A being emitted towards nanopore 820 is shown as is an emitted radiation beam 822B from a polymer (not shown) crossing through nanopore 820 and emitting fluorescence. As mentioned above in FIG. 14, emitted light beam 822A does not need to be emitted perpendicularly to the surface of metal film 818 (as shown) and can be emitted at various angles towards metal film 818 and nanopore 820. First arrangement 810 has the advantage of using a minimal amount of metal to form metal film 818 for concentrating the EM field and the photonic excitation of emitted light beam 822A towards nanopore 820. This may also provide cost benefits when metal film 818 is made from a costly metal (for example gold).

Reference is now made to FIG. 16, which is a schematic illustration of a second arrangement of the EM concentration layer of the fluorescence-based detection system using nanopores of FIG. 14, generally referenced 850, constructed and operative in accordance with a further embodiment of the disclosed technique. As mentioned above, FIG. 16 only shows the ionic solution, nanopore membrane layer and EM concentration layer (for example as a metal film layer) from the fluorescence-based detection system of FIG. 14. With reference to a top view 852A, shown is an EM concentration layer 858 (embodied as a metal film 858), a nanopore membrane 856, including a nanopore 860 and an ionic solution 854. Ionic solution 854 and nanopore membrane 856 are also shown as cutaways (with dotted lines) in metal film 858 to show their layered structure within top view 852A (and as mentioned above would not be seen from a top view in an actual embodiment of this arrangement). As seen in comparison to metal film 818 (FIG. 15), metal film 858 has an hourglass structure etched into itself in which nanopore 860 is positioned (which is somewhat but not completely opposite to the bowtie structure shown above in FIG. 15). In this arrangement, metal film 858 substantially covers all of nanopore membrane 856 except for the etched out hourglass structure concentrated primarily near nanopore 860. Whereas this appears to be the opposite of the bowtie structure shown above in FIG. 15, the electrical polarizations of the two structures are different and are not the opposite of one another. The etched out hourglass structure forms an opening within metal film 858 leading to nanopore 860. Thus in this arrangement, light beams are concentrated towards nanopore 860 via a hole (i.e., the hourglass structure) in metal film 858 surrounding an area substantially larger than nanopore 860. The hole in metal film 858 contains most of the illumination providing photonic excitation specifically near and close to nanopore 860. When light beams (not shown) are directed towards metal film 858, and specifically nanopore 860, metal film 858, due to its conductive nature as a metal, attracts and concentrates the light beams towards into its hourglass structure towards nanopore 860, thereby generating a strong EM field and strong photonic excitation near nanopore 860. As explained above, this mitigates the diffraction limit of the light used to illuminate the container by concentrating a larger portion of the illumination light beam towards nanopore 860 thus enabling greater fluorescence to be emitted and detected from a polymer (not shown) passing through nanopore 860 and being illuminated by light beams (and thus minimizing the energy losses of the illuminating light beam). Using the same quantities and dimensions as described above for a bowtie structure in FIG. 15, the hourglass structure of FIG. 16 can have a range of dimensions which can be tweaked depending on the specific design of second arrangement 850. Metal film 858 can have a gap length 865 ranging from 4-40 nm with a lens length 864 ranging from 50-400 nm. The acuteness of an angle marker 867 can range from 20-140 degrees and flattened width 866 can range from 0-40 nm (0 nm in the case of a triangle tip or vertex (not shown)).

With reference to a side view 852B, ionic solution 854, nanopore membrane 856 and metal film 858 can be seen along with their relative thicknesses and positions. As shown, nanopore 860 has a diameter 870 ranging between 4-40 nm. Nanopore membrane 856 has a thickness 869 which can range from 20-100 nm whereas metal film 858 has a thickness 868 which can range from 20-300 nm. An emitted light beam 862A being emitted towards nanopore 860 is shown as is an emitted radiation beam 862B from a polymer (not shown) crossing through nanopore 860 and emitting fluorescence. It is noted that in this embodiment, emitted light beam 862A can also be emitted from the opposite side of metal film 858, meaning from under nanopore membrane 856 through nanopore 860 to towards metal film 858. In addition, whether emitted light beam 862A is emitted from above metal film 858 or below nanopore membrane 856, emitted light beam 862A can be emitted in a perpendicular direction to metal film 858 (as shown) or at an angle, as described above in FIG. 14. An opening 859 within metal film 858 represents the hourglass structure etched in metal film 858 and is substantially another embodiment of opening 784 (FIG. 14). Second arrangement 850 has the advantage of blocking much of the emitted light beams coming from the light source (not shown) due to the opaque nature of metal film 858 as metal film 858 may be thick enough across most of its specified dimensions to be opaque to the emitted light beams. Thus as mentioned, the light source can be positioned either above or below nanopore 860 thereby enabling significantly less of emitted light beam 862A from reaching the detector (not shown). For example, in the case of the light source being positioned below nanopore membrane 856, the structure of opening 859 reduces the amount of light beams reaching the detector which may be positioned above metal film 858. This correspondingly increases the amount of radiation beams 862B reaching the detector. It is noted as well that even though FIGS. 15 and 16 both appear to represent opposite structures for the metal film, the natures of the bowtie structure of FIG. 15 and the hourglass structure of FIG. 16 (with one being an embossed metal film and the other being engraved in the metal film) generate different polarizations of the EM field generated in the vicinity of the nanopore. The different polarizations in FIGS. 15 and 16 may be useful for different types of polymers which are to be scanned and analyzed by the disclosed technique. It is noted as well that from a manufacturing point of view, the structures of FIGS. 15 and 16 are different as the structure of FIG. 15 is formed by deposition whereas the structure of FIG. 16 is formed by etching. The structure of FIG. 15 may provide increased detection of emitted fluorescence from a polymer passing through the nanopore when the light source and detector are both located above the container (i.e., on the same side) as the EM concentration layer functions as both a mirror and a blocker of EM radiation. The structure of FIG. 16 may provide increased detection of emitted fluorescence from a polymer passing through the nanopore when the light source and detector are located on opposite sides of the container as the opaque nature of the EM concentration layer provides shielding to the detector of stray light coming from the light source.

Reference is now made to FIG. 17, which is a schematic illustration of a third arrangement of the EM concentration layer of the fluorescence-based detection system using nanopores of FIG. 14, generally referenced 890, constructed and operative in accordance with another embodiment of the disclosed technique. Similar to FIG. 15 and FIG. 16, FIG. 17 only shows the ionic solution, nanopore membrane layer and EM concentration layer (for example as a metal film) from the fluorescence-based detection system of FIG. 14. With reference to a top view 892A, shown is an EM concentration layer 898 (embodied as a metal film 898), a nanopore membrane 896, including a nanopore 900 and an ionic solution 894. Ionic solution 894 and nanopore membrane 896 are also shown as cutaways (with dotted lines) in metal film 898 to show their layered structure within top view 892A. As mentioned above, the cutaways would not be visible from a top view in an actual embodiment of this arrangement. As seen in comparison to metal film 858 (FIG. 16), metal film 898 also has a structure etched into itself surrounding nanopore 900. In this arrangement, metal film 898 substantially covers all of nanopore membrane 896 except for the etched out structure concentrated primarily near nanopore 900. As mentioned above, metal film 898 is to cover a significant area surrounding nanopore 900 in order to concentrate the EM field around nanopore 900 however if nanopores are positioned relatively far from one another, for example one nanopore every 8000-10000 nm, then metal film 898 may only need to surround each nanopore for a radius of 2000-4000 nm (or even less depending on the wavelength of the light beams used to illuminate the nanopores) however beyond that radius (but before reaching the environs of an adjacent nanopore) nanopore membrane 896 may not necessarily have a metal film above it. The etched out structure forms an opening within metal film 898 leading to nanopore 900. Thus in this arrangement, light beams are concentrated towards nanopore 900 via a hole (i.e., an engraved structure) in metal film 898 surrounding an area substantially larger than nanopore 900. The hole in metal film 898 contains most of the illumination providing photonic excitation specifically near and close to nanopore 900. When light beams (not shown) are directed towards metal film 898, and specifically nanopore 900, metal film 898, due to its conductive nature as a metal, attracts and concentrates the light beams towards into its engraved structure towards nanopore 900, thereby generating a strong EM field and strong photonic excitation near nanopore 900. As explained above, this mitigates the diffraction limit of the light beams used to illuminate a polymer (not shown) passing through the nanopore and thus enables greater fluorescence to be emitted and detected from the polymer passing through nanopore 900 and being illuminated by light beams.

As compared to FIG. 16, the engraved structure of FIG. 17 has an H-shape (or I-shape), substantially consisting of two rectangular portions connected near the area of the nanopore. Similar quantities and dimensions as described above for the bowtie structure in FIG. 15 can be used to describe the H-shape of the engraved structure of FIG. 17. And similar to FIG. 16, the engraved structure of FIG. 17 can have a range of dimensions which can be tweaked depending on the specific design of third arrangement 890. Metal film 898 can have a gap length 906 ranging from 4-40 nm with a lens length 904 ranging from 50-400 nm. A width 905 can range from 30-250 nm and a center height 907 can range from 0-40 nm (0 nm in the case of the upper and lower rectangles of the H-shape being adjacent to one another (not shown)).

With reference to a side view 892B, ionic solution 894, nanopore membrane 896 and metal film 898 can be seen along with their relative thicknesses and positions. As shown, nanopore 900 has a diameter 910 of between 4-40 nm. Nanopore membrane 896 has a thickness 909 which can range from 20-100 nm whereas metal film 898 has a thickness 908 which can range from 20-300 nm. An emitted light beam 902A being emitted towards nanopore 900 is shown as is an emitted radiation beam 902B from a polymer (not shown) crossing through nanopore 900 and emitting fluorescence. Emitted light beam 902A may also be emitted from the underside of nanopore membrane 896 through nanopore 900 and towards metal film 898. An opening 899 within metal film 898 represents the engraved H-shaped structure etched in metal film 898 and is substantially a further embodiment of opening 784 (FIG. 14). Third arrangement 890 has a similar advantage to second arrangement 850 (FIG. 16) of blocking much of the emitted light beams coming from the light source (not shown) due to the opaque nature of metal film 898 surrounding at least a significant portion of nanopore membrane 896. Thus the light source can be positioned either above or below nanopore 900 thereby enabling significantly less of emitted light beam 902A from reaching the detector (not shown). For example, in the case of the light source being positioned below nanopore membrane 896, the structure of opening 899 reduces the amount of light beams reaching the detector which may be positioned above metal film 898. This correspondingly increases the amount of radiation beams 902B reaching the detector. And likewise, emitted light beam 902A, whether emitted from above metal film 898 or from below nanopore membrane 896, can be emitted in a perpendicular direction (as shown) or at a various angles (as shown above in FIG. 14). Third arrangement 890 has another advantage regarding the H-shape structure. Since an H-shape lacks angled lines (as compared to the bowtie structure of FIG. 15 or the hourglass structure of FIG. 16 which have angled lines), the H-shape of third arrangement 890 may easier, simpler and more cost effective to manufacture in metal film 898 using certain manufacturing technologies. For example, in optical lithography (which can be used to manufacture the disclosed technique), when the resolution required is close to the diffraction limit used, it is easier and simpler to have all mask lines be consistent with regards to the polarization (which is the case for an H-shape but not for a bowtie shape or an hourglass shape). In addition, in scanning-based manufacturing methods such as electron beam lithography and focused ion beam (as known as FIB) lithography, not all lithography machines can execute vector scanning (which can etch diagonal lines). Some lithography machines can only etch using raster scanning and thus there is an advantage in not having an etch pattern with diagonal lines.

It is noted that the structures of the EM concentration layers as explained above in FIGS. 15-17 and as explained below in FIG. 22, are shown with the EM concentration layer positioned above the nanopore membrane. It is noted that according to the disclosed technique, the EM concentration layers of FIGS. 15-17 and 22 can be positioned either above the nanopore membrane or below the nanopore membrane, thus having the EM concentration layer being adjacent to the nanopore membrane.

Reference is now made to FIG. 18, which is a schematic illustration of a second configuration of a fluorescence-based detection system using nanopores and waveguides, generally referenced 920, constructed and operative in accordance with a further embodiment of the disclosed technique. Second configuration 920 includes a reaction chamber 922 (also referred to as simply a container 922), a solid state membrane 926 (also referred to as a nanopore membrane 926), a dielectric film 928 (which acts as a waveguide layer), an ionic solution 924, a light source, a detector 934 and a detector filter 936. Container 922 may be positioned on or combined with a substrate (not shown) for mechanical support. Shown as well is an optical element 939 which is an optional element. FIG. 18 shows three different positions and setups for the light source. In a first position, a light source 942A is embedded in container 922 and in such an embodiment second configuration 920 includes an optical element 943. Optical element 943 may be a sub-wavelength structure, a mirror or can be embodied as a prism. In a second position, a light source 942B is positioned outside container 922 and adjacent to dielectric film 928. In this embodiment second configuration 920 includes a collimating lens 946. In a third position, a light source 942C is positioned above container 922 at an angle. In this embodiment second configuration 920 includes a sub-wavelength deformation zone 948 within dielectric film 928. As can be seen, each of the three positions optically couples the light source with the waveguide layer via an optical element, wherein in the first position the optical element is optical element 943 (defined in more detail below), in the second position, the optical element is a collimating lens and in the third position the optical element is a sub-wavelength deformation zone. Container 922 contains ionic solution 924, nanopore membrane 926 and dielectric film 928. Container 922 may also be coupled with a substrate (not shown). As shown, nanopore membrane 926 includes a nanopore 932. Dielectric film 928 has an opening 930, which as shown, is positioned over nanopore 932 and is slightly larger than nanopore 932. Light source 942A is positioned such that an emitted light beam 944A is directed towards dielectric film 928. Optical element 943 is positioned in dielectric film 928 and reflects emitted light beam 944A into dielectric film 928 (as shown). Light source 942B emits light beam 944B towards collimating lens 946 which collimates and focuses light beam 944B into dielectric film 928 (as shown). Collimating lens 946 may include an optional light source filter (not shown) for enabling at least one specific range of wavelengths of light to pass there through towards container 922 and dielectric film 928. Light source 942C emits light beam 944C towards ionic solution 924 and dielectric film 928. Sub-wavelength deformation zone 948 is positioned along dielectric film 928 to receive emitted light beam 944C and to focus it along the length of dielectric film 928 (as shown). It is noted that part of the disclosed technique involves the use of a sub-wavelength deformation zone for introducing light beams into a waveguide layer (i.e., a dielectric film) without having to collimate the light beams (such as in the case of light source 942B) into the very small and nanometer sized entrance of dielectric film 928 (not labeled). Similar to first configuration 760 (FIG. 14), light source 942C can be positioned at various angles with respect to dielectric film 928 and not just at the angle shown in FIG. 18, including being positioned under container 922 (in which case, dielectric film 928 may be positioned under (not shown) nanopore membrane 926. It is noted that in this configuration, container 922 may be made from a transparent material such that light sources 942A and 942B can emit light beams which travel through container 922 into dielectric film 928. It is noted as well that in a given embodiment of second configuration 920, the light source is only positioned in one of the shown positions in FIG. 18 along with the corresponding elements of that position used to enter the emitted light beam into dielectric film 928. As an example, if light source 942A is used, then dielectric film 928 does not include sub-wavelength deformation zone 948. As mentioned above optical element 939 is an optional element and may be embodied as a microscope lens, collimating lens and the like for focusing light onto detector 934. Whereas second configuration 920 can function without optical element 939, optical element 939 enables more of the radiation beams given off of a polymer crossing through nanopore 932 to be focused onto detector 934.

Dielectric film 928 substantially acts as a waveguide for transmitting light beams along its length, thus dielectric film 928 can also be referred to as a waveguide layer 928. Dielectric film 928 keeps an emitted light beam within its structure using the principles of TIR, as described, for example, above in reference to FIG. 6. Emitted light beam 944A (or 944B or 944C) thus passes through waveguide layer 928, passing over opening 930 and nanopore 932. As explained above, the use of dielectric film 928 allows for a significant increase in the percentage of an illuminating light beam to be used to illuminate a polymer passing through nanopore 932. Since the diffraction limit of the light used in the disclosed technique may be hundreds of nanometers and the nanopore size is on the order of tens of nanometers, using an EM concentration layer (as shown above in the first configuration of FIG. 14) can help mitigate the energy losses of such a light beam which are not used to actually illuminate the polymer in the ionic solution, however there is a limit as to how much of the illuminating light beam can be focused and concentrated into the nanopore. In second configuration 920, as shown in each of the positions of light sources 942A, 942B and 942C, even with a diffraction limit of hundreds of nanometers, most of the energy of an illuminating light beam can be focused into waveguide layer 928, thus enabling a significant increase in illuminating energy which can be brought to opening 930 and used to illuminate a polymer passing through nanopore 932. The use of waveguide layer 928 can substantially eliminate the existence of unused excitation energy which might otherwise have propagated directly or indirectly (via reflections) to the detector, or have generated background fluorescence received by the detector, both of which could be sources of noise for the detector. As shown, an emitted light beam propagating within waveguide layer 928 may continue to propagate along the waveguide layer even after passing over opening 930, as shown by an arrow 950 representing the continuing propagation of an emitted light beam. Emitted light beam 944A (or 944B or 944C) can excite a polymer 940 passing through nanopore 932, which then produces fluorescence as an emitted radiation beam 938. As described above, polymer 940 is a polymer of interest for analysis purposes. As shown, polymer 940 is placed in ionic solution 924 which acts as a neutral medium (i.e., ionic solution 924 does not interact with polymer 940). Similar to first configuration 760 (FIG. 14), ionic solution 924 enables polymer 940 to float around and eventually pass through nanopore 940 without interacting with polymer 940 and without ionic solution 924 emitting fluorescence itself. When emitted light beam 944A (or 944B or 944C) interacts with polymer 940, polymer 940 produced an emitted radiation beam 938. As mentioned above, the use of waveguide layer 928 enables a significant amount of energy of the illuminating light beam to interact with polymer 940, thus enabling a significant increase in the amount of fluorescence emitted by polymer 940. Emitted radiation beam 938 is emitted towards detector 934, optionally through optical element 939. Detector filter 936 prevents any stray light beams from, for example, light source 942C (and any other light source in the area) as well as radiation light beams outside the expected wavelength range of radiation light beams emitted from polymer 940 from reaching detector 934. Detector filter 936 may be an optional component. Detector 934 may be coupled with an analyzer (not shown) and/or a processor (not shown) for determining and analysis at least a portion of the constituents of polymer 940 based on emitted radiation beam 938. As mentioned above, the analysis can also include fingerprinting of polymer 940, in which only a small portion of the constituents of polymer 940 need to be identified.

Regarding dimensions, nanopore membrane 926 may have a thickness ranging from 20-100 nm, with nanopore 932 having a diameter between 4-40 nm. Dielectric film 928 may have a thickness of 50-800 nm, with opening 930 having a gap length of between 50-300 nm. In general, dielectric film 928 is embodied as a strip acting as a waveguide layer. Dielectric film 928 can thus also be embodied as a ridge which is embossed out of nanopore membrane 926. Whereas not shown in FIG. 18, dielectric film 928 may have a width ranging from 200-1200 nm. This is shown more clearly below in FIGS. 19-21. As in first configuration 760 (FIG. 14), nanopore 932 may be formed by drilling (i.e., chemical etching or physical etching) through nanopore membrane 926, thus giving nanopore 932 a cylindrical or circular shape.

Similar to FIG. 14, FIG. 18 shows a single container with a nanopore membrane exhibiting a single nanopore and a dielectric film exhibiting a single opening. This is merely for illustrative purposes. Container 922 may be part of an array of containers (not shown), each container including a nanopore membrane with a respective nanopore and a dielectric film with a respective opening. In another embodiment, nanopore membrane 926 may include a plurality of nanopores and dielectric film 928 may include a corresponding plurality of openings for a single container. Polymer 940 may be placed in a given concentration in ionic solution 924. In the case of an array of containers, a plurality of different polymers of interest may be placed in each container for separate determination and analysis and/or fingerprinting. Also similar to FIG. 14, in second configuration 920, electrical current can be applied to ionic solution 924 in order to induce polymer 940 to move through nanopore 932. Likewise, a concentration gradient of molecules in the solution in container 922 can be established in order to generate a flow for inducing polymer 940 to move through nanopore 932. Also, other methods for inducing a flow within the solution through nanopore 932 can be used, for example by fabricating nanopore membrane 926 as an active membrane which threads polymers such as DNA and RNA there through.

Regarding the introduction of light beams into container 922, second configuration 920 resembles the different setups of FIGS. 6, 7, 9 and 10 described above, wherein light beams are introduced into a fluorescence-based detection system using waveguides and can be introduced via collimating lenses, sub-wavelength deformation zones or having at least one light source embedded in the container. In second configuration 920, light sources 942A, 942B and 942C and detector 934 are designed to function within the general bounds of the visible light spectrum. Thus light sources 942A-942C can emit light beams in the range of around 400 nm to 850 nm in wavelength, give or take about 100 nm on either limit. And likewise, detector 934 can detect emitted radiation beams in the same general range. Furthermore, light source 942A may polarize emitted light beam 944A, wherein the polarization may be linear or circular (and likewise for light sources 942B and 942C). The polarization of emitted light beam 944C can also be perpendicular to the surface of dielectric film 928 or at another angle in relation to the surface of dielectric film 928 depending on the particular design dimensions of second configuration 920. Any one of light source 942A-942C can be embodied as a laser diode or an LED, and in the case of light source 942A, as an embedded laser diode (or LED).

As mentioned above, first configuration 760 (FIG. 14) and second configuration 920 are substantially similar in design, however second configuration 920 replaces the EM concentration layer of first configuration 760 with a dielectric film acting as a waveguide layer. This change also enables a different placement of the light source in second configuration 920 with the advantage of distancing the light source from the detector. As mentioned above, another advantage is that a waveguide layer can capture a significantly larger portion of the energy of a light beam and propagate that energy to a nanopore than an EM concentration layer as a waveguide layer can collect light over a much larger area that an opening in an EM concentration layer placed near a nanopore. The waveguide layer in second configuration 920 thus acts as a lens with a plurality of focusing points for focusing light beams to a nanopore. In addition, regarding fabrication, nanopore membrane 926 and dielectric film 928 can be made from the same material wherein a strip in the layer of the material is used as the waveguide layer. In such an embodiment, nanopore membrane 926 and dielectric film 928 may be a monolithic structure however nanopore membrane 926 serves the purposes of having a nanopore within it whereas dielectric film 928 serves the purposes of enabling light beams to propagate through it. Said otherwise, even as a monolithic structure, such a structure according to the disclosed technique requires two sections or parts, one wherein a nanopore is located and another wherein light beams can be propagated. In another embodiment nanopore membrane 926 and dielectric film 928 are made from different materials. In either embodiment, a gap or opening is opened up in the dielectric film just over nanopore 932 for concentrating light beams in opening 930, thereby increasing the EM field and photonic excitation of polymer 940 as it passes through nanopore 932 and opening 930 while simultaneously barring photonic excitation elsewhere in container 922. Second configuration 920, which uses waveguides to propagate light beams to opening 930, has the advantage of decoupling the area from which radiation beams from polymer 940 are collected and detected from the area where light beams are propagated to opening 930. Such a setup significantly blocks light beams originating from any of the light sources shown in FIG. 18 from reaching detector 934 and also significantly increases the concentration of light beams and thus photonic excitation in the area and vicinity around opening 930 and nanopore 932 as the light beams are brought precisely and in concentrated form to opening 930.

Reference is now made to FIG. 19, which is a schematic illustration of a first arrangement of the waveguides of the fluorescence-based detection system using nanopores and waveguides of FIG. 18, generally referenced 960, constructed and operative in accordance with another embodiment of the disclosed technique. FIG. 19 only shows the ionic solution, nanopore membrane layer and dielectric film layer from the fluorescence-based detection system of FIG. 18 however it is clear that the elements of FIG. 18 not shown in FIG. 19 apply to FIG. 19 as well, for example the container, the light source and the detector. FIG. 19 shows a first arrangement of the layers of the detection system from a top view 962A as well as from a side view 962B. Side view 962B is along a line A-A 961, similar to line A-A 811 (FIG. 15), in the direction of a plurality of arrows 963. Identical reference numbers are used for elements shown in both top view 962A and side view 962B. It is noted that the above description applies to the second and third arrangements of the dielectric film and waveguide layer, shown below in FIGS. 20 and 21 respectively, regarding only showing the ionic solution, nanopore membrane layer and waveguide layer from the fluorescence-based detection system of FIG. 18 and also regarding showing a top view and a corresponding side view of the particular arrangement. It is noted that the above mention regarding the relationship of the top view to the side view applies to FIG. 20 as well however not to FIG. 21, in which the relationship between the two views of that figure is different and is explained therein.

With reference to top view 962A, shown is a dielectric film 966, a nanopore membrane 964, including a nanopore 968 and an ionic solution 970. Ionic solution 970 is shown as a cutaway (with dotted lines) in nanopore membrane 964 as otherwise it would not be seen from top view 962A. As mentioned above, the cutaway would not be seen from the top view of an actual embodiment of this arrangement. As seen, dielectric film 966 is a strip acting as a waveguide layer above nanopore membrane 964. It is noted that the dielectric film could also be placed below the nanopore membrane (not shown) and that according to the disclosed technique, the dielectric film is adjacent to the nanopore membrane, either being above it or below it. The strip has an opening 969 which is positioned over nanopore 968. Light beams travelling through dielectric film 966 thus cross over nanopore 968 through opening 969. The light beams in opening 969 thus generate a very strong EM field and very strong photonic excitation near nanopore 968. As explained above, this enables greater fluorescence to be emitted and detected from a polymer (not shown) passing through nanopore 968 and being illuminated by light beams travelling through dielectric film 966. As shown, dielectric film 966 can have a width 973 of between 200-1200 nm. A gap length 972 demarcating the length of opening 969 can be between 50-300 nm. Dielectric film 966 can be embodied as having a square end bordering opening 969 (as shown in solid lines) or can be embodied having a curved end 967 bordering opening 969 (shown in dotted lines). In the embodiment of curved end 967, the ends of dielectric film 966 bordering opening 969 are shaped like lenses which can further concentrate the EM field generated by the light beams propagating through dielectric film 966 to opening 969 and nanopore 968. In this embodiment, the gap length would be measured from a flat end portion 971 of dielectric film 966.

With reference to side view 962B, ionic solution 970, nanopore membrane 976 and dielectric film 966 can be seen along with their relative thicknesses and positions. As shown, nanopore 968 has a diameter 977 of between 4-40 nm. Nanopore membrane 964 has a thickness 976 which can range from 20-100 nm whereas dielectric film 966 has a thickness 975 which can range from 50-800 nm. An emitted light beam 974A propagating through dielectric film 966 towards nanopore 968 and opening 969 is shown as is an emitted radiation beam 974B from a polymer (not shown) crossing through nanopore 968 and emitting fluorescence. As mentioned above in FIG. 18, emitted light beam 974A may be emitted from a light source which is either embedded in the container (not shown), positioned adjacent to the container near dielectric film 966 or above dielectric film 966 and focused onto a sub-wavelength deformation zone (not shown) within dielectric film 966. The light source could also be placed below nanopore membrane 964 however in such a case the dielectric film would also be placed below the nanopore membrane. First arrangement 960 has the clear advantages of separating the propagation of light beams (974A) to opening 969 from the emission of radiation beams (974B) from the polymer to a detector (not shown) and concentrating a significant portion of the energy of the light beams (not shown) transmitted to dielectric film 966 which then propagate along dielectric film 966 as emitted light beam 974A.

Reference is now made to FIG. 20, which is a schematic illustration of a second arrangement of the waveguides of the fluorescence-based detection system using nanopores and waveguides of FIG. 18, generally referenced 990, constructed and operative in accordance with a further embodiment of the disclosed technique. FIG. 20 only shows the ionic solution, nanopore membrane layer and dielectric film layer from the fluorescence-based detection system of FIG. 18. Second arrangement 990 includes some elements of first configuration 760 (FIG. 14) which are not shown in second configuration 920 (FIG. 18), such as an EM concentration layer (for example a metal film) alongside a waveguide layer. With reference to a top view 992A, shown is an EM concentration layer 1000 (embodied as a metal film 1000), a nanopore membrane 998, including a nanopore 1002, a dielectric film 996 and an ionic solution 994. As shown metal film 1000 is the uppermost layer, followed by nanopore membrane 998, with dielectric film 996 being the bottommost layer above ionic solution 994. As dielectric film 996 is embodied as a strip under nanopore membrane 998, dielectric film 996 is shown in dotted lines. In addition, ionic solution 994, dielectric film 996 and nanopore membrane 998 are shown as a cutaway (with dotted lines) in metal film 1000 to show their layered structure. As mentioned above, the cutaways sections would not be visible from a top view of an actual embodiment of this arrangement. Dielectric film 996 acts as a waveguide layer positioned under nanopore membrane 998 whereas metal film 1000 acts as an EM field concentrator and radiation shield above nanopore membrane 998. Both metal film 1000 and dielectric film 996 have an opening positioned over nanopore 1002, with the opening in metal film 1000 being slightly larger than the opening in dielectric film 996 (seen more clearly in side view 992B). Whereas metal film 1000 is shown having a square opening, the actual shape and structure of the opening can be any of the shapes and structures of the opening in the metal films shown above in FIGS. 15-17. The opening in metal film 1000 can also be shaped as other known shapes (circular, elliptical, rectangular and the like). Light beams travelling through dielectric film 996 thus cross over nanopore 1002 through the opening (not labeled). The light beams in the opening of dielectric film 996 are thus concentrated in the area near nanopore 1002. Whereas the opening in metal film 1000 also aids in concentration the EM field and increasing the photonic excitation near nanopore 1002, the main function of metal film 1000 in this arrangement is acting as a radiation shield and shielding the detector (not shown) from any light beams that may leak out of dielectric film 996 in the direction of the detector. The focusing of light beams into the area of nanopore 1002 via dielectric film 996 which causes increased photonic excitation (along with the shielding from metal film 1000) enables greater fluorescence to be emitted and detected (with less noise and interference) from a polymer (not shown) passing through nanopore 1002. It is noted that in this arrangement, metal film 1000 can be replaced with a dielectric interference filter for serving the purpose of shielding the detector from any stray light beams leaking out of dielectric film 996. As shown, dielectric film 996 can have a width 1004 of between 200-1200 nm. A gap length 1003 demarcating the length of the opening (not labeled) in dielectric film 996 can be between 50-300 nm. Similar to first arrangement 960 (FIG. 19), dielectric film 996 can be embodied as having a square end bordering the opening or can be embodied having a curved end shaped like a lens bordering the opening.

With reference to a side view 992B, ionic solution 994, dielectric film 996, nanopore membrane 998 and metal film 1000 can be seen along with their relative thicknesses, positions and layering. As shown, dielectric film 996 is positioned under nanopore membrane 998 whereas metal film 1000 is positioned above nanopore membrane 998. Nanopore 1002 has a diameter 1011 of between 4-40 nm. Nanopore membrane 998 has a thickness 1008 which can range from 20-100 nm, dielectric film 996 has a thickness 1009 which can range from 50-800 nm and metal film 1000 has a thickness 1010 which can range from 20-300 nm. An emitted light beam 1006A propagating through dielectric film 996 towards nanopore 1002 is shown as is an emitted radiation beam 1006B from a polymer (not shown) crossing through nanopore 1002 and emitting fluorescence. As mentioned above in FIG. 18, emitted light beam 1006A may be emitted from a light source which is either embedded in the container (not shown), positioned adjacent to the container near dielectric film 996 or below dielectric film 996 in this embodiment and focused onto a sub-wavelength deformation zone (not shown) within dielectric film 996. Shown as well are an opening 1005 in dielectric film 996 and an opening 1007 in metal film 1000. As shown, opening 1005 may be slightly smaller than opening 1007. Second arrangement 990 has the advantage of separating the propagation of light beams (1006A) to opening 1005 from the emission of radiation beams (1006B) from the polymer to a detector (not shown). In addition, this arrangement has the advantage of providing increased EM field concentration and photonic excitation in the area around nanopore 1002, for example in opening 1007, and for providing shielding to the detector from stray beams of light that might leak out of dielectric film 996 due to the opaque nature of metal film 1000. It is noted that dielectric films 928 (FIG. 18), 966 (FIG. 19) and 996 (FIG. 20) can be made out of any of the following materials: SiO₂, TiO₂, Ta₂O₅, Nb₂O₅, Si₃N₄, Al₂O₃, SiN_{X} (where ‘x’ represents a ratio of silicon to nitrogen which is typically determined by the stress requirements of the dielectric film in a given arrangement), PMMA (poly(methyl methacrylate)) or PDMS (polydimethylsiloxane).

It is noted that FIG. 20 as drawn shows metal film 1000 as being above nanopore membrane 998 and dielectric film 996 as being below nanopore membrane 998 however according to the disclosed technique, the positioning of the layers can be swapped, with dielectric film 996 being position above nanopore membrane 998 and metal film 1000 positioned below nanopore membrane 998. According to a further embodiment of the disclosed technique, as mentioned above, the dielectric layer and the nanopore membrane can be manufactured from the same material, having a monolithic structure with one section acting as the nanopore membrane and another section acting as the waveguide layer. In such a case, the metal film may be positioned on either side of such a structure, thus giving such an arrangement the following possibilities: i) a metal film as the uppermost layer, followed by a nanopore membrane and then a waveguide layer (as shown in FIG. 20), ii) a metal film as the uppermost layer, followed by a waveguide layer and then a nanopore membrane, iii) a nanopore membrane as the uppermost layer, followed by a waveguide layer and then a metal film, and iv) a waveguide layer as the uppermost layer, followed by a nanopore membrane and then a metal film (as described just above). Thus the metal film can be positioned on either side of a monolithic structure which includes a waveguide layer and a nanopore membrane. The order of the layering in such an embodiment may be a function of the kind of manufacturing used to fabricate the various layers and on which side of the structure it is easier to fabricate the nanopore membrane which is the thinnest of the layers in such a structure.

Reference is now made to FIG. 21, which is a schematic illustration of a third arrangement of the waveguides of the fluorescence-based detection system using nanopores and waveguides of FIG. 18, generally referenced 1030, constructed and operative in accordance with another embodiment of the disclosed technique. As described below, third arrangement 1030 includes a waveguide but does not include a dielectric film. FIG. 21 thus only shows the ionic solution, the nanopore membrane layer and EM concentration layer (acting as a waveguide layer) from the fluorescence-based detection system of FIG. 18. As shown, the EM concentration layer is embodied as a metal film. With reference to a top view 1032A, shown is a metal film 1038, a nanopore membrane 1036, including a nanopore 1040 and an ionic solution 1034. Ionic solution 1034 and nanopore membrane 1036 are shown as a cutaway (with dotted lines) in metal film 1038. As mentioned above, the cutaway section would not be visible from a top view of an actual embodiment of this arrangement. It is noted that FIG. 21 shows a side view 1032B along a line B-B 1031 in the direction of a plurality of arrows 1033 and that side view 1032B is along a different plane than the side views shown in FIGS. 15-17 and 19-20. Metal film 1038 is located above nanopore membrane 1036 wherein a strip of metal film 1038 has been removed (i.e., etched away) to form a waveguide 1042 within metal film 1038. Whereas metal film 1038 itself does not act as a waveguide, waveguide 1042 enables light beams to travel there through and cross over nanopore 1040. Metal film 1038 enables the concentration of an EM field and strong photonic excitation near nanopore 1040. As explained above, the use of a waveguide enables an increase in the amount of energy from illuminating light beams that can be focused and concentrated around nanopore 1040 despite the diffraction limit of the light beams being larger than the width of the waveguide. Increasing the amount of energy from a transmitted light beam to nanopore 1040 enables greater fluorescence to be emitted and detected from a polymer (not shown) passing through nanopore 1040 and being Illuminated by light beams travelling through waveguide 1042. As shown, waveguide 1042 can have a width 1044 of between 10-200 nm. According to the disclosed technique, the metal film is adjacent to nanopore membrane 1036 and can be embodied as either being above nanopore membrane 1036 (as shown) or below nanopore membrane 1036 (not shown).

With reference to side view 1032B, ionic solution 1034, nanopore membrane 1036 and metal film 1038 can be seen along with their relative thicknesses and positions. Waveguide 1042 is also shown as a strip (and not just an opening) within metal film 1038. As shown, nanopore 1040 has a diameter 1047 of between 4-40 nm. Nanopore membrane 1036 has a thickness 1045 which can range from 20-100 nm whereas metal film 1038 has a thickness 1046 which can range from 20-300 nm. An emitted light beam 1048A propagating through waveguide 1042 towards nanopore 1040 is shown as is an emitted radiation beam 1048B from a polymer (not shown) crossing through nanopore 1040 and emitting fluorescence after having reacted with emitted light beam 1048A. Third arrangement 1030 has the advantage of separating the propagation of light beams (1048A) through waveguide 1042 from the emission of radiation beams (1048B) from the polymer to a detector (not shown). This arrangement also has the advantage of not requiring a dielectric layer to function as a waveguide layer, thus simplifying the manufacturing of such a structure.

In third arrangement 1030, light beams can be entered into waveguide 1042 in a number of ways. In one embodiment, a sub-wavelength deformation zone (not shown) can be formed in metal film 1038 for injecting light beam 1048A into waveguide 1042, similar to light source 942C (FIG. 18) and sub-wavelength deformation zone 948 (FIG. 18). In another embodiment, light beam 1048A can be entered directly into waveguide 1042 via a light source, with a collimating lens for collimating light beam 1048A with the opening (not labeled) of waveguide 1042, similar to light source 942B (FIG. 18) and collimating lens 946 (FIG. 18). This embodiment may require a matching structure at the entrance to waveguide 1042. In a further embodiment, light beam 1048A may be emitted from an embedded light source, similar to light source 942A (FIG. 18). In this embodiment, a prism (not shown) might be needed to reflect light from the embedded light source into waveguide 1042. Due to waveguide 1042 being exposed to ionic solution 1034 from above and surrounded by metal film 1038 on the sides and nanopore membrane 1036 below, light travelling within waveguide 1042 will substantially propagate along its length and remain within waveguide 1042 due to the principles of TIR and the different dielectric coefficients of metal film 1038, ionic solution 1034 and nanopore membrane 1036.

Reference is now made to FIG. 22, which is a schematic illustration of a fourth arrangement of the EM concentration layer of the fluorescence-based detection system using nanopores of FIG. 14, generally referenced 1060, constructed and operative in accordance with a further embodiment of the disclosed technique. Similar to FIG. 15, FIG. 22 only shows the ionic solution, nanopore membrane layer and EM concentration layer (for example as a metal film) from the fluorescence-based detection system of FIG. 14. With reference to a top view 1062A, shown is a metal film 1068, a nanopore membrane 1066, including a nanopore 1070 and an ionic solution 1064. Ionic solution 1064 and nanopore membrane 1066 are also shown as cutaways (with dotted lines) in metal film 1068 to show their layered structure within top view 1062A. As mentioned above, the cutaway section would not be visible from a top view in an actual embodiment of this arrangement. As seen in comparison to metal films 858 (FIG. 16) and 898 (FIG. 17), metal film 1068 also has an engraved structure etched into itself surrounding nanopore 1070. The engraved structure of this arrangement is in the form of a sub-wavelength grating 1072, shown as a plurality of concentric arcs surrounding one side of nanopore 1070. In this arrangement, metal film 1068 substantially covers all of nanopore membrane 1070 except for the etched out sub-wavelength grating structure concentrated primarily near nanopore 1070 which also includes a circular opening (not labeled) surrounding nanopore 1070. In this arrangement, light beams are concentrated towards nanopore 1070 via the etched out sections in metal film 1068 surrounding nanopore 1070. The etched out sections in metal film 1068 focus and concentrate most of the illumination providing photonic excitation specifically near and in the direction of nanopore 1070. When light beams (not shown) are directed towards metal film 1068, and specifically nanopore 1070, metal film 1068, due to its conductive nature as a metal, attracts and concentrates (similar to an antenna) the light beams into its engraved structure towards nanopore 1070, thereby generating a strong EM field and strong photonic excitation near nanopore 1070. As explained above, this structure mitigates energy losses due to the diffraction limit of the light beams used to illuminate the nanopore and thus enables greater fluorescence to be emitted and detected from a polymer (not shown) passing through nanopore 1070 and being illuminated by light beams. The dimensions of sub-wavelength grating 1072 can have a range of dimensions which can be tweaked depending on the specific design of fourth arrangement 1060 and can be described as follows. Metal film 1068 can have an opening width 1075 ranging from 10-200 nm. Sub-wavelength grating 1072 formed out of metal film 1068 is shown in FIG. 22 having three arcs, each having a span of approximately 180 degrees. However sub-wavelength grating 1072 can be embodied having anywhere between one to ten arcs etched out of metal film 1068, where each arc can have a span ranging from 30 to 360 degrees (in which case the arc is actually a circle). Sub-wavelength grating 1072 can have a radius 1074 ranging from tens to hundreds of nanometers depending on the grating pitch and arc index of each arc. For example, sub-wavelength grating 1072 may have a grating pitch 1076 per arc ranging from 50-300 nm, and if the first arc has a grating pitch of 100 nm, the third arc may have radius 1074 measuring 300 nm. Each arc in sub-wavelength grating 1072 can have a grating fill factor ranging from 25%-75%. The arcs of sub-wavelength grating 1072 may be approximately circular however their shape may include certain corrections to compensate for light polarization, actual structure, specific dimensions and materials of manufacture. For example, phase offset may be introduced across the arcs of sub-wavelength grating 1072 as their orientations change with respect to light polarization. Such phase offsets could be compensated for (i.e., via applying a polarization related correction) by moving specific points along the arcs either closer or further from the center of the arcs (which substantially coincide with the position of nanopore 1070), which might change the shape of each arc from being circular to being more elliptical. The amount of phase offset to compensate for depends on the material of construction of metal film 1068 as well as its specific dimensions.

With reference to a side view 1062B, ionic solution 1064, nanopore membrane 1066 and metal film 1068 can be seen along with their relative thicknesses and positions. As shown, nanopore 1070 has a diameter 1077 of between 4-40 nm. Nanopore membrane 1066 has a thickness 1079 which can range from 20-100 nm whereas metal film 1068 has a thickness 1078 which can range from 20-300 nm. An emitted light beam 1080A being emitted towards nanopore 1070 is shown as is an emitted radiation beam 1080B from a polymer (not shown) crossing through nanopore 1070 and emitting fluorescence. As can be seen, emitted light beam 1080A is actually emitted towards sub-wavelength grating 1072, which diverts and focuses emitted light beams towards nanopore 1070. Whereas emitted light beam 1080A is shown in FIG. 22 to be at an angle to metal film 1068, emitted light beam 1080A can be emitted at various angles (including being perpendicular) with respect to metal film 1068, similar to the positioning of light source 774′ (FIG. 14). In addition, emitted light beam 1080A can be emitted from the underside of the arrangement, meaning from under nanopore membrane 1066 towards metal film 1068, similar to the arrangements shown above in FIGS. 15-17. An opening 1069 within metal film 1068 represents the circular opening surrounding nanopore 1070 and etched in metal film 1068 and is substantially another embodiment, along with sub-wavelength grating 1072, of opening 784 (FIG. 14). As shown, opening 1069 is slightly wider than diameter 1077. When viewed from the side, the grating structure of sub-wavelength grating 1072 is clearly seen. Fourth arrangement 1060 has the advantage of blocking much of the emitted light beams coming from the light source (not shown) due to the opaque nature of metal film 1068. This arrangement also provides for increased EM concentration of EM radiation towards nanopore 1070 due to its grating structure which functions like an antenna for attracting EM radiation. An increase in the number of arcs used in sub-wavelength grating 1072 may increase the physical amount of EM radiation that can be concentrated towards nanopore 1070 however an increase in the number of arcs in this structure also causes an increase in the selectivity of the frequencies attracted (which might lead to less EM radiation actually being attracted and concentrated towards nanopore 1070 at certain frequencies). Thus the light source can be positioned either above or below nanopore 1070 thereby enabling significantly less of emitted light beam 1080A from reaching the detector (not shown). For example, in the case of the light source being positioned below nanopore membrane 1066, the structure of sub-wavelength grating 1072 and opening 1069 reduces the amount of light beams reaching the detector which may be positioned above metal film 1068. This correspondingly increases the amount of radiation beams 1080B reaching the detector.

It is noted in general that the two configurations described above in FIGS. 14 and 18 and in greater detail in FIGS. 15-17 and 19-22 according to the disclosed technique, demonstrate that the disclosed technique provides a solution to at least two different problems associated with biosensors and fluorescence-based detection systems that use nanopores. A first problem concerns how to concentrate an EM field near a nanopore to get increased fluorescence from the polymer of interest which is illuminated by light beams. As mentioned above, this problem stems from the diffraction limit of the light beams used to illuminate the nanopore which are at least one order of magnitude larger than the order of magnitude of the nanopore itself. As shown in some of the embodiments above, this issue can be aided by using a metal film having specific shapes and structures which the inventors have discovered increase EM field concentration near a nanopore and thus mitigate energy losses due to the aforementioned diffraction limit. And as shown in other embodiments above, this issue can be significantly mitigated by using a waveguide layer (either via a dielectric film or by etching a waveguide layer within a metal film) for concentrating a significant portion of the energy of illuminating light beams towards a nanopore. A second problem revolves around how to reduce the amount of stray light (i.e., light beams from the light source or from the environment) that might be received directly by the detector which is not emitted radiation (i.e., fluorescence) from the polymer of interest. As shown in some of the embodiments above, this issue can be aided by using a dielectric film acting as a waveguide layer which substantially distances the light source and the propagation of emitted light beams from the detector and the emission of radiation beams from the polymer of interest. Even though the issue of reducing stray light can be somewhat mitigated by the use of a detector filter, as described above, the disclosed technique enables stray light to be reduced without having to rely on a detector filter. Stray light (including fluorescence emitted from polymers not passing through the nanopore) can reach the detector thus causing noise in the detected fluorescence from the polymer of interest. Stray light can also reach other portions of the container not near the nanopore, thereby potentially causing background fluorescence to be created which a filter in front of the detector may not be able to mitigate as the background fluorescence may be within the same wavelength range as the expected fluorescence from the polymer of interest. The use of a dielectric film thus enables a significant reduction of stray light coming from other sections of the container and in the ionic solution besides the area in and around the nanopore. It is noted as well that according to the disclosed technique, the use of a dielectric film along with a metal film for sandwiching a nanopore membrane having a nanopore aids in reducing stray light in general since on the scale of the detection system, which is on the order of tens to hundreds of nanometers, it is challenging to keep emitted light beams within a dielectric film from escaping from the dielectric film to a degree. The use of a metal film in such an embodiment, as shown above in FIG. 20, significantly aids in reducing stray light from the dielectric film, as well as stray light and fluorescence from polymers not near the nanopore, from reaching the detector as the metal film acts as a natural barrier for stopping stray light from the dielectric film and from other areas in the container and the ionic solution from reaching the detector. Thus in the detection system as shown above in FIG. 20, having the metal film above the nanopore membrane and the dielectric film below the nanopore membrane not only enables light beams to be concentrated near the nanopore, the arrangement can also aid in blocking any stray light leaving the dielectric film and attempting to propagate towards the detector when the detector is positioned above the metal film.

It is noted that the designs and structures of the fluorescence-based detection systems described above which utilize a nanopore (FIGS. 14-22) may be different than the fluorescence-based detection systems described above which do not utilize a nanopore (FIGS. 2-13) and can be used for different purposes and for different kinds of chemical analyses. One difference involves the ways in which a biomaterial and/or polymer of interest is illuminated and thus the kinds of analyses that can be done accordingly based on the method of illumination.

Is it noted as well that according to the disclosed technique, a portion of the fluorescence-based detection systems described above which do not utilize a nanopore (in particular FIGS. 6-12) however which do use waveguides for propagating light to a container for illuminating a biomaterial, can be combined with some of the embodiments of the fluorescence-based detection systems described above which do utilize nanopores and a waveguide layer (in particular FIGS. 18-21). For example, in the fluorescence-based detection systems which include a waveguide (such as waveguide 353 (FIG. 6) which includes core 360 (FIG. 6)), this waveguide can be one and the same with the waveguide layer of the fluorescence-based detection systems which include a nanopore (for example dielectric film 996 (FIG. 20)). Similarly, the cladding (such as lower cladding layer 358 (FIG. 6)) is one and the same as the nanopore membrane (for example nanopore membrane 998 (FIG. 20) or nanopore membrane 964 (FIG. 19)). In as much as an EM concentration layer is used (for example EM concentration layer 1000 (FIG. 20)), such a layer can either replace or be added on top of the upper cladding layer (for example upper cladding layer 362 (FIG. 6)). The vertical cavities (i.e., openings) associated with the nanopore structures (such as shown in FIGS. 19-21) can be respectively etched through all the layers in the fluorescence-based detection systems which include a waveguide (for example etching the vertical cavities through physical filter 356, photodetector 354 and substrate 352 (all in FIG. 6)). In such combined embodiments instead of having a biomaterial sample in the container (such as biomaterial 366 (FIG. 6)), a polymer of interest would be placed floating in the container.

As mentioned above, the devices and structures as described in the disclosed technique may be manufactured using technologies and practices common in the semiconductor and microelectromechanical systems industries. As is known, a silicon wafer may be used as the mechanical basis for any of the structures described above on top of which various dielectric layers and/or metallic layers can be constructed by known deposition techniques (for example MBE (molecular beam epitaxy), CVD (chemical vapor deposition), PVD (physical vapor deposition), EVD (electrochemical vapor deposition) and ALD (atomic layer deposition)), coating techniques (for example spin coating) and/or chemical reactions (for example thermal oxidation). Patterning of the various layers may be done using known lithographic methods (for example, optical lithography, ultraviolet lithography, extreme ultraviolet lithography, electron-beam lithography and focused ion beam lithography), followed either by an etching technique and/or a drilling technique (for example via wet etching techniques such as potassium hydroxide (KOH) etching and/or buffered oxide etchant (BOE), or dry etching techniques such as reactive-ion etching) and/or lift-off techniques.

It will be appreciated by persons skilled in the art that the disclosed technique is not limited to what has been particularly shown and described hereinabove. Rather the scope of the disclosed technique is defined only by the claims, which follow.

1. A device for fluorescence-based detection of at least one polymer, the device comprising:
at least one container comprising:
a nanopore membrane, comprising at least one nanopore; and
a waveguide layer, comprising at least one first opening,
at least one light source, optically coupled with said waveguide layer, for generating at least one light beam for illuminating said at least one polymer;
at least one detector, for detecting at least one emission emitted from said illuminated at least one polymer; and
at least one first optical element, for entering said at least one light beam into said waveguide layer,
wherein said at least one first opening is positioned substantially in line with said at least one nanopore;
wherein said at least one polymer is placed within a solution within said at least one container;
wherein said at least one polymer is illuminated by said at least one light beam propagating through said waveguide layer through said at least one first opening; and
wherein said illuminated at least one polymer emits said at least one emission as it passes through said at least one nanopore and said at least one first opening.

2. The device for fluorescence-based detection according to claim 1, wherein said waveguide layer is a dielectric film positioned adjacent to said nanopore membrane.

3. The device for fluorescence-based detection according to claim 2, wherein at least one end of said dielectric film bordering said at least one first opening has a shape selected from the list consisting of:
a square end; and
a curved end.

4. The device for fluorescence-based detection according to claim 1, wherein said waveguide layer is a dielectric film positioned on one side of said nanopore membrane;
wherein said device further comprises an electromagnetic (EM) concentration layer positioned on the other side of said nanopore membrane;
wherein said EM concentration layer comprises at least one second opening, also positioned in line with said at least one nanopore; and
wherein said illuminated at least one polymer emits said at least one emission as it also passes through said at least one second opening.

5. The device for fluorescence-based detection according to claim 4, wherein said EM concentration layer is a metal film.

6. The device for fluorescence-based detection according to claim 1, wherein said waveguide layer is a dielectric film positioned on one side of said nanopore membrane;
wherein said device further comprises a dielectric interference filter positioned on the other side of said nanopore membrane; and
wherein said dielectric interference filter comprises at least one second opening, also positioned in line with said at least one nanopore.

7. The device for fluorescence-based detection according to claim 1, wherein said waveguide layer is a metal film positioned adjacent to said nanopore membrane having a waveguide etched into said metal film.

8. The device for fluorescence-based detection according to claim 7, wherein said waveguide etched into said metal film is positioned over said at least one first opening.

9. The device for fluorescence-based detection according to claim 1, wherein said at least one light source is embedded in said at least one container; and
wherein said at least one first optical element is positioned inside said waveguide layer, for directing said at least one light beam emitted from said at least one light source into said waveguide layer.

10. The device for fluorescence-based detection according to claim 9, wherein said at least one first optical element is selected from the list consisting of:
a sub-wavelength structure;
a mirror; and
a prism.

11. The device for fluorescence-based detection according to claim 1, wherein said at least one light source is positioned outside said at least one container and adjacent to said waveguide layer;
wherein said at least one first optical element is a collimating lens, positioned between said at least one light source and an entrance to said waveguide layer; and
wherein said collimating lens focuses said at least one light beam emitted from said at least one light source into said waveguide layer.

12. The device for fluorescence-based detection according to claim 1, wherein said at least one light source is positioned at an angle to said at least one container;
wherein said at least one first optical element is a sub-wavelength deformation zone within said waveguide layer; and
wherein said sub-wavelength deformation zone focuses said at least one light beam emitted from said at least one light source into said waveguide layer.

13. The device for fluorescence-based detection according to claim 1, further comprising an analyzer, coupled with said at least one detector, for analyzing said at least one emission.

14. The device for fluorescence-based detection according to claim 1, further comprising a second optical element, positioned between said at least one detector and said at least one container, for directing said at least one emission towards said at least one detector.

15. The device for fluorescence-based detection according to claim 1, further comprising at least one respective detector filter, positioned between said at least one detector and said container.

16. The device for fluorescence-based detection according to claim 1, wherein a wavelength of said at least one light beam is between 400 and 850 nanometers.

17. The device for fluorescence-based detection according to claim 1, wherein said solution is an ionic solution.

18. The device for fluorescence-based detection according to claim 1, wherein said solution comprises a concentration gradient.

19. The device for fluorescence-based detection according to claim 1, wherein said at least one polymer is selected from the list consisting of:
an organic compound;
an inorganic compound;
a protein;
a polypeptide;
DNA;
RNA; and
a lipid.

20. The device for fluorescence-based detection according to claim 1, wherein said waveguide layer is made from a material selected from the list consisting of:
SiO₂
TiO₂;
Ta₂O₅;
Nb₂O₅;
Si₃N₄;
Al₂O₃;
SiNₓ;
poly(methyl methacrylate) (PMMA); and
polydimethylsiloxane (PDMS).

21. The device for fluorescence-based detection according to claim 1, wherein said nanopore membrane is made from a material selected from the list consisting of:
SiNₓ; and
silicon dioxide (SiO₂).

22. The device for fluorescence-based detection according to claim 1, wherein said nanopore membrane and said waveguide layer are made from the same material and form a monolithic structure; and
wherein said nanopore membrane and said waveguide layer have a relative positioning selected from the list consisting of:
said nanopore membrane being positioned above said waveguide layer in said monolithic structure; and
said nanopore membrane being positioned below said waveguide layer in said monolithic structure.

23. The device for fluorescence-based detection according to claim 22, wherein said device further comprises an electromagnetic (EM) concentration layer positioned adjacent to said monolithic structure, said EM concentration layer having a relative positioning to said monolithic structure selected from the list consisting of:
said EM concentration layer being positioned above said monolithic structure; and
said EM concentration layer being positioned below said monolithic structure.

24.-69. (canceled)

70. A device for fluorescence-based detection of at least one polymer, the device comprising:
at least one container comprising:
a nanopore membrane, comprising at least one nanopore; and
a waveguide layer, comprising at least one first opening,
at least one light source, optically coupled with said waveguide layer, for generating at least one light beam for illuminating said at least one polymer;
at least one detector, for detecting at least one emission emitted from said illuminated at least one polymer;
at least one first optical element, for entering said at least one light beam into said waveguide layer; and
at least one second optical element, positioned between said at least one detector and said at least one container, for focusing said at least one emission onto said at least one detector,
wherein said at least one first opening is positioned substantially in line with said at least one nanopore;
wherein said at least one polymer is placed within a solution within said at least one container;
wherein said at least one polymer is illuminated by said at least one light beam propagating through said waveguide layer through said at least one first opening;
wherein said illuminated at least one polymer emits said at least one emission as it passes through said at least one nanopore and said at least one first opening; and
wherein said at least one emission is detected by said at least one detector by means of free-space propagation.

71. The device for fluorescence-based detection according to claim 70, wherein said waveguide layer is a dielectric film positioned on one side of said nanopore membrane;
wherein said device further comprises an electromagnetic (EM) concentration layer positioned on the other side of said nanopore membrane;
wherein said EM concentration layer comprises at least one second opening, also positioned in line with said at least one nanopore; and
wherein said illuminated at least one polymer emits said at least one emission as it also passes through said at least one second opening.

72. The device for fluorescence-based detection according to claim 70, wherein said at least one light source is embedded in said at least one container; and
wherein said at least one first optical element is positioned inside said waveguide layer, for directing said at least one light beam emitted from said at least one light source into said waveguide layer.

73. The device for fluorescence-based detection according to claim 72, wherein said at least one first optical element is selected from the list consisting of:
a sub-wavelength structure;
a mirror; and
a prism.

74. The device for fluorescence-based detection according to claim 70, wherein said at least one second optical element is selected from the list consisting of:
a microscope lens;
a collimating lens;
a lens; and
an optical coupler.

75. The device for fluorescence-based detection according to claim 70, wherein said at least one light source is positioned outside said at least one container and adjacent to said waveguide layer;
wherein said at least one first optical element is a collimating lens, positioned between said at least one light source and an entrance to said waveguide layer; and
wherein said collimating lens focuses said at least one light beam emitted from said at least one light source into said waveguide layer.

76. The device for fluorescence-based detection according to claim 70, further comprising at least one respective detector filter, positioned between said at least one detector and said container.
